(19) United States
(12) Patent Application Publication
(10) Pub. No.: US 2008/0082984 A1
(43) Pub. Date: Apr. 3, 2008

(54) Methods, apparatus and storage medium for use in association with a dataflow system

(75) Inventor: Richard Gary McDaniel, Highstown, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Technology-to-Business Center, LLC

(21) Appl. No.: 11/807,292

(22) Filed: May 24, 2007

Related U.S. Application Data
(60) Provisional application No. 60/848,424, filed on Sep. 29, 2006.

(51) Int. Cl. G06F 9/46

(52) U.S. Cl. 718/106

(57) ABSTRACT

According to a first aspect, a method comprises: receiving, in a processing system, data representing a dataflow network, the dataflow network including a first node and a second node, the first node having an output, the second node having an input connected to the output of the first node, and determining, in the processing system, whether to execute the second node based at least in part on whether the first node has data to present.

### CROSS-REFERENCE TO RELATED APPLICATION

This application claims priority under 35 U.S.C. § 119 to U.S. Provisional Patent Application Ser. No. 60/848,424, entitled “Inline List Iteration in a DataFlow Network”, filed in the name of Richard Gary McDaniel on Sep. 29, 2006, the contents of which are hereby incorporated by reference in their entirety for all purposes.

### TECHNICAL FIELD

The present disclosure relates to methods, apparatus, products and/or storage medium for use in association with dataflow systems, and in some embodiments, to methods, apparatus, and/or products that (1) extend the semantics of a dataflow network language to provide manipulation of set, list, and array-like data and/or (2) include semantics and node definitions that enable a single, simple network to perform computations on aggregated values.

### BACKGROUND

A graphical (or visual) programming language is any programming language that lets users specify programs by manipulating program elements graphically instead of by specifying them textually. Graphical programming languages allow programming with visual expressions, spatial arrangements of text and graphic symbols. Generally, graphical programming languages are based on the idea of “boxes and arrows,” that is, boxes or circles or bubbles, treated as screen objects, and connected by arrows, lines, edges or arcs.

Graphical programming languages may be further classified, according to the type and extent of visual expression used, into icon-based languages, form-based languages, and diagram languages. Visual programming environments provide graphical or iconic elements which can be manipulated by users in an interactive way according to some specific spatial grammar for program construction. Graphical programming languages or techniques can include flow charts, finite state machines, dataflow networks, and the like.

A flow chart is a type of graphical programming language that closely mirrors the program semantics of a textual language. Different kinds of nodes (e.g., “begin”, “end”, “procedure” and “condition”) can exist in a flow chart, and the text inside each node denotes the actual computation (e.g., a procedure node contains text that performs an action, a condition node contains text that describes a choice). The execution semantics of a flow chart are explicit. There exists a virtual program counter that denotes the current node which is being executed. The program counter is initialized to be the begin node, and directed edges connecting the nodes of the flow chart indicate which paths the program counter is allowed to follow. In flow charts, there is a “flow” of control and not the flow of data (i.e., there are no values associated with the edges of a flow chart). The programming semantic of flow charts is imperative (i.e., the computation proceeds step by step where the order of instruction execution is determined by the graph connectivity of the edges) and is not declarative.

A finite state machine is another type of graphical programming language, in that a finite state machine is a simple computer represented by nodes (representing possible states) and directed edges that are labeled. A stream of tokens, which are values representing some action or event, is presented to the system in sequence. The finite state machine is a processor of events, and there is a program counter that refers to the current node or state that the finite state machine has active. The labels on the edges correspond to possible tokens that may arrive in the stream, and the edges indicate the “flow” of control representing the paths the program counter may take. The labels of the edges are not data or values, as they do not change in a finite state machine. When a token from the stream arrives, it is compared to the labels of each of the edges emanating from the node currently referenced by the program counter (this node is the “state” of the finite state machine). One of the labels should match the token, and the program counter then moves to the node that is pointed to by the edge having the matching label. The process is then repeated with the next token in the stream.

A dataflow language is another graphical programming language or technique that uses nodes and lines in a diagram to form a dataflow network. Nodes in the diagram represent functions and the lines (also called edges) represent the transfer of parameters from one function to another. Nodes have two kinds of edge connections labeled input and output. An edge is always connected from a node output to a node input. To operate, data is retrieved from the edges connected to the node's input, a function is applied to that data, and then the results of the function are presented to the node's output edges. Execution of a dataflow network is implicit, and an outside influence like a timer tells the computer to evaluate the network's nodes. A node with no input connections is called a “source” and is used to retrieve data values from some external process. A node with no output connections is a “sink” and is used to collect and present data. The dataflow program runs by having the computer repeatedly execute all the nodes in an implied loop. Every time the loop executes, new external data is applied to the source nodes, the intermediate nodes are evaluated, and data is retrieved from the sink nodes. The data therefore “flows” in dataflow networks and the edges are seen as conduits for data values. Dataflow networks are declarative (i.e., it is declared that expressions exist between sources and sinks via the expression graph and the computer is responsible for keeping the values up to date).

In current practice, dataflow languages are defined with limited node connectivity options. The programmer does not have the ability to change the kinds of connections that a node defines. The data value that an edge represents is always limited to a single, fixed-size value. Even if the value is an array-like value, it is limited to a fixed number of elements. Nodes that can process multiple values must do so by having as many input connections as the maximum number of values it can process.

Some dataflow languages provide overloading where a node input and output can accept more than one kind of data value. For example, an addition operator may define semantics for a single scalar value or a fixed-size vector of values. However, overloading only applies to those nodes for which it is defined. Other nodes that were not defined to operate on vectors of values cannot do so implicitly.

Some dataflow languages provide semantics for performing computation using a second, embedded, dataflow network similar to a procedure call. The embedded network is stored within a single node of the overlying dataflow network. When the single node is invoked in the main network, the nodes of the embedded network are invoked to generate the result. Embedded networks can be used to implement loop-like behavior where the embedded dataflow network is executed many times each time the parent node is executed.

Many applications use dataflow networks. Two dataflow applications in common use today are LAB VIEW by NATIONAL INSTRUMENTS (see “LabVIEW: Getting Started with LabVIEW”, National Instruments) and SIMULINK by THE MATHWORKS (see “Simulink: Simulation and Model-Based Design Getting Started.” Version 6.0, The MathWorks, Inc.).

Each implementation of a dataflow language is unique but shares common properties with other dataflow languages. A dataflow network always consists of a set of node and line diagrams. The nodes and lines may be rendered using typical computer graphical user interface displays. Nodes are shown as a box or icon of some sort. The shape and size of different types of nodes can vary widely. Likewise, the lines that represent edges can be drawn in a variety of ways. The methods for creating the diagrams generally use a direct manipulation interface.

Notwithstanding the current state of dataflow systems, further methods, apparatus, and/or products for use in association with a dataflow system are desired.

### SUMMARY

According to a first aspect, a method comprises: receiving, in a processing system, data representing a dataflow network, the dataflow network including a first node and a second node, the first node having an output, the second node having an input connected to the output of the first node; and determining, in the processing system, whether to execute the second node based at least in part on whether the first node has data to present.

According to another aspect, a storage medium having stored thereon instructions that if executed by a machine, result in the following: receiving, in a processing system, data representing a dataflow network, the dataflow network including a first node and a second node, the first node having an output, the second node having an input connected to the output of the first node; and determining, in the processing system, whether to execute the second node based at least in part on whether the first node has data to present.

According to another aspect, an apparatus comprises: means for receiving data representing a dataflow network, the dataflow network including a first node and a second node, the first node having an output, the second node having an input connected to the output of the first node; and means whether to execute the second node based at least in part on whether the first node has data to present.

According to another aspect, an apparatus comprises: a processing system to (1) receive data representing a dataflow network, the dataflow network including a first node and a second node, the first node having an output, the second node having an input connected to the output of the first node; and (2) determine whether to execute the second node based at least in part on whether the first node has data to present.

According to another aspect, a method comprises: receiving, in a processing system, data representing a dataflow network, the dataflow network including a first node and a second node, the first node having an output, the second node having an input connected to the output of the first node; and executing the first node to determine whether to execute the second node.

According to another aspect, an apparatus comprises: a processing system to (1) receive data representing a dataflow network, the dataflow network including a first node and a second node, the first node having an output, the second node having an input connected to the output of the first node and (2) execute the first node to determine whether to execute the second node.

Some embodiments of some aspects may define semantics for managing and computing aggregated, list-like values in a dataflow network without using embedded networks.

Some embodiments of some aspect may define nesting implicitly based on the kinds of nodes in the network rather than have the programmer explicitly nest nodes.

Some embodiments of some aspects may relax the type restrictions imposed by current dataflow networks. Dataflow edges (and the node connection points) may be permitted to transmit lists of values without fixing the size of the value a priori.

Some embodiments of some aspects may provide semantics where nodes may be invoked multiple times in a single program cycle. These semantics may allow a node to produce a stream of values iteratively to the successive nodes in the network without embedding those nodes in a secondary network. The successive nodes may be invoked as many times as is necessary to operate on each value. Nodes may also be used to collect the values of an iterated stream and regress out of the implicit nesting.

In some embodiments of some aspects allows a dataflow network to perform loop-like, iterative behavior within a single diagram without using special-purpose graphical conventions. A second network may not be needed to perform the computation of an inner loop.

Although various features, attributes and/or advantages may be described herein and/or may be apparent in light of the description herein, it should be understood that unless stated otherwise, such features, attributes and/or advantages are not required and need not be present in all aspects and/or embodiments.

### BRIEF DESCRIPTION OF THE DRAWINGS

Further aspects of the present invention will be more readily appreciated upon review of the detailed description of the preferred embodiments included below when taken in conjunction with the accompanying drawings, of which:

FIG. 1A is a dataflow diagram showing an example of dataflow program semantics that may be used in defining a dataflow network, in accordance with some embodiments;

FIG. 1B is a dataflow diagram showing an example of dataflow program semantics that may be used in defining a dataflow network, in accordance with some embodiments;

FIG. 2A is a dataflow diagram showing an example of dataflow program semantics that may be used in defining a dataflow network, in accordance with some embodiments;

FIG. 2B is a dataflow diagram showing an example of dataflow program semantics that may be used in defining a dataflow network, in accordance with some embodiments;

FIG. 2C is a dataflow diagram showing an example of dataflow program semantics that may be used in defining a dataflow network, in accordance with some embodiments;

FIG. 2D is a dataflow diagram showing an example of dataflow program semantics that may be used in defining a dataflow network, in accordance with some embodiments;

FIGS. 3A-3B are dataflow diagrams showing examples of dataflow program semantics that may be used in defining a dataflow network, in accordance with some embodiments;

FIG. 4 is a dataflow diagram showing an example of dataflow program semantics that may be used in defining a dataflow network, in accordance with some embodiments;

FIG. 5 is a dataflow diagram showing an example of dataflow program semantics that may be used in defining a dataflow network, in accordance with some embodiments;

FIG. 6 is a flow chart of a method according to some embodiments;

FIG. 7A is a flow chart of a method according to some embodiments;

FIG. 7B is a flow chart of a method according to some embodiments;

FIG. 8 is a representation showing an example of a simulation that may be used in association with a dataflow network, in accordance with some embodiments;

FIG. 9 is a dataflow diagram showing an example of a dataflow network that may be used in association with the simulation of FIG. 8, in accordance with some embodiments;

FIG. 10A is a diagram showing the simulation of FIG. 8 in association with the dataflow diagram of FIG. 9;

FIG. 10B is a representation of the operation of the simulation of FIG. 8 in association with the dataflow diagram of FIG. 9;

FIG. 11 is a dataflow diagram showing an example of dataflow program semantics that may be used in defining a dataflow network, in accordance with some embodiments;

FIG. 12 is a dataflow diagram showing an example of dataflow program semantics that may be used in defining a dataflow network, in accordance with some embodiments;

FIG. 13 is a dataflow diagram showing an example of a dataflow network that may be used in association with the simulation of FIG. 8, in accordance with some embodiments;

FIG. 14 is an example of an if-then statement in a standard programming language;

FIG. 15 is a dataflow diagram showing an example of dataflow program semantics that may be used in defining a dataflow network, in accordance with some embodiments;

FIG. 16 is a dataflow diagram showing an example of a dataflow network that may be used in association with the simulation of FIG. 8, in accordance with some embodiments;

FIG. 17 is a dataflow diagram showing an example of dataflow program semantics that may be used in defining a dataflow network, in accordance with some embodiments;

FIG. 18A is a dataflow diagram showing an example of dataflow program semantics that may be used in defining a dataflow network, in accordance with some embodiments;

FIG. 18B is a dataflow diagram showing an example of dataflow program semantics that may be used in defining a dataflow network, in accordance with some embodiments;

FIG. 18C is a dataflow diagram showing an example of dataflow program semantics that may not be permitted in defining a dataflow network, in accordance with some embodiments;

FIG. 19A is a dataflow diagram showing an example of dataflow program semantics that may be used in defining a dataflow network, in accordance with some embodiments;

FIG. 19B is a dataflow diagram showing an example of dataflow program semantics that may not be permitted in defining a dataflow network, in accordance with some embodiments;

FIG. 19C is a dataflow diagram showing an example of dataflow program semantics that may not be permitted in defining a dataflow network, in accordance with some embodiments;

FIG. 20 is a diagram showing an example of an order and groups for nodes of a dataflow diagram in accordance with some embodiments;

FIG. 21 is a flow chart of a method according to some embodiments;

FIG. 22 is a flow chart of a method according to some embodiments;

FIG. 23 is a flow chart of a method according to some embodiments;

FIG. 24A is a dataflow diagram showing an example of a dataflow network and an implied dependency that may be determined for the dataflow network, in accordance with some embodiments;

FIG. 24B is a dataflow diagram showing an example of a dataflow network and implied dependencies that may be determined for the dataflow network, in accordance with some embodiments;

FIG. 25A is a dataflow diagram showing an example of a dataflow network and an implied dependency that may be determined for the dataflow network, in accordance with some embodiments;

FIG. 25B is a dataflow diagram showing an example of a dataflow network and an implied dependency that may be determined for the dataflow network, in accordance with some embodiments;

FIG. 26 is a dataflow diagram showing an example of a dataflow network and an implied dependency that may be determined for the dataflow network, in accordance with some embodiments;

FIG. 27 is a diagram showing an example of dependencies, in accordance with some embodiments;

FIGS. 28A-28H show an example of how nodes of a dataflow diagram may be sorted and grouped, in accordance with some embodiments; and

FIG. 29 is a block diagram of a processing system in accordance with some embodiments.

### DETAILED DESCRIPTION OF SPECIFIC EMBODIMENTS

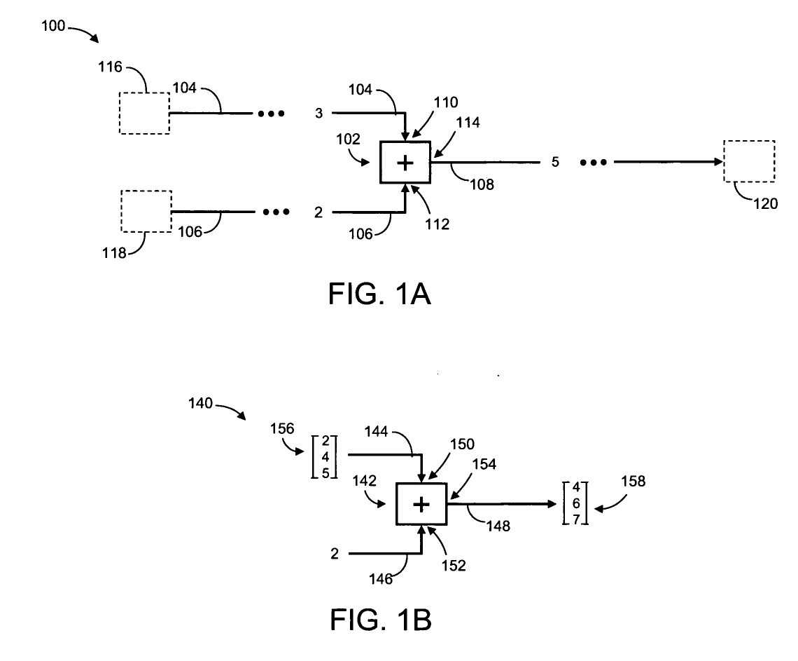

FIG. 1A is a dataflow diagram 100 showing an example of dataflow program semantics that may be used in defining a dataflow network, in accordance with some embodiments. Referring to FIG. 1A, the dataflow diagram 100 includes a node 102 and three edges 104, 106, 108. The node 102 has two inputs 110, 112 and one output 114. The first edge 104 is connected to the first input 110. The second edge 106 is connected to the second input 112. The third edge 108 is connected to the output 114.

The node denotes (or defines) a self-contained unit of computation. For example, the node 102 defines an addition operator (sometimes referred to herein as an addition node). In that regard, a first value (e.g., 3) may be supplied to the first input 110 of the node 102. A second value (e.g., 2) may be supplied to the second input 112 of the node 102. The node 102 may add the values (e.g., 3 and 2) supplied thereto, to determine a value (e.g., 5) which may be supplied (or presented) by the output 114 of the node 102.

An edge connected to an input of a node may define a source of values to be supplied to such input. For example, the first edge 104 defines a node, e.g., node 116, as a source of values for the first input 110 of the node 102. The second edge 106 defines a node, e.g., node 118, as a source of values for the second input 112 of the node 102.

An edge connected to an output of a node may define where values computed by a node are supplied and/or used. For example, the edge 108 connected to the output 114 of the node 102 defines a node, e.g., node 120, that receives (or takes) and/or uses the values supplied by the node 102. In some embodiments, an edge may include an arrow that indicates a direction of “data flow”.

A node may be an addition node, e.g., node 102, or any other type of node. Thus, a node (1) may have any number and/or type of inputs and/or outputs and (2) may define any number and/or type of functions. In some embodiments, a dataflow diagram may include any number of nodes and/or any number of edges.

In some embodiments, a user may utilize a graphical user interface to define one or more portions of a dataflow diagram and/or a dataflow network. As further described hereinafter, in some embodiments, a node may be defined to allow the node to accept a vector of values on one or more inputs of the node.

FIG. 1B is a dataflow diagram 140 showing an example of dataflow program semantics that may be used in defining a dataflow network, in accordance with some embodiments. Referring to FIG. 1B, the dataflow diagram 140 includes a node 142 and three edges 144, 146, 148. The node 142 has two inputs 150, 152 and one output 154. The first edge 144 is connected to the first input 150. The second edge 146 is connected to the second input 152. The third edge 148 is connected to the output 154.

The node 142 has been defined in advance to allow the node 142 to receive a vector, e.g., vector 156, at the first input 150 (sometimes referred to herein as an overloaded input connection) of the node 142. The vector 156 may include a plurality of first values (e.g., 2, 4, 5). The second input 152 of the node 142 may receive a second value (e.g., 2). The node 142 may add the second value (e.g., 2) to each value in the vector 156 to determine a vector of results, e.g., vector 158, which may be supplied by the output 154 of the node 142. For example, the node 142 may add the second value (e.g., 2) to the first value (e.g., 2) in the vector 156 to determine a first value (e.g., 4) in the vector of results 158. The node 142 may add the second value (e.g., 2) to the second value (e.g., 4) in the vector 156 to determine a second value (e.g., 6) in the vector of results 158. The node 142 may add the second value (e.g., 2) to the third value (e.g., 5) in the vector 156 to determine a third value (e.g., 7) in the vector of results 158.

As further described hereinafter, in some embodiments, a node may be a property retrieval node to retrieve a property of an object.

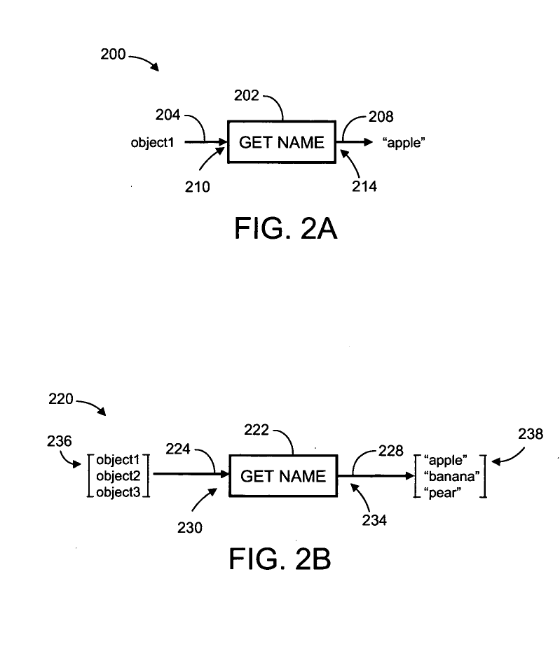

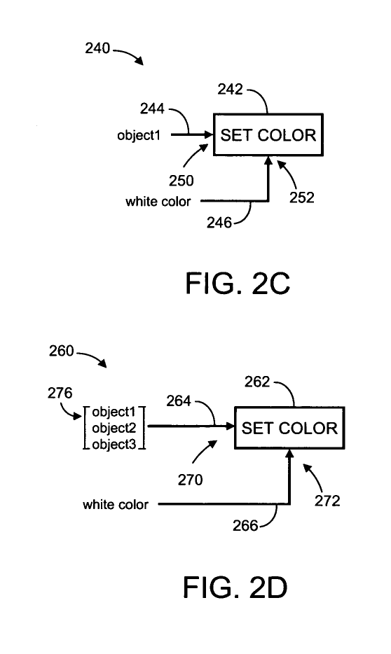

FIG. 2A is a dataflow diagram 200 showing an example of dataflow program semantics that may be used in defining a dataflow network, in accordance with some embodiments. Referring to FIG. 2A, the dataflow diagram 200 includes a node 202 and two edges 204, 208. The node 202 has one input 210 and one output 214. The first edge 204 is connected to the first input 210. The second edge 208 is connected to the output 214.

In some embodiments, the node 202 may be a property retrieval node. For example, the node 202 may be a “name” property retrieval node that retrieves the “name” property of an object. In that regard, a reference to an object, e.g., object 1, may be supplied to the input 210 of the node 202. In accordance with some embodiments, the object may be an internal object and/or an external object. The node 202 may determine the “name” property (e.g., “apple”) of the object, e.g., object 1, and the “name” property may be supplied by the output 214 of the node 202.

As further described hereinafter, in some embodiments, a property retrieval node may be defined to allow the node to accept a vector of object references on one or more inputs of the node.

FIG. 2B is a dataflow diagram 220 showing an example of dataflow program semantics that may be used in defining a dataflow network, in accordance with some embodiments. Referring to FIG. 2B, the dataflow diagram 220 includes a node 222 and two edges 224, 228. The node 222 has one input 230 and one output 234. The first edge 224 is connected to the first input 230. The second edge 228 is connected to the output 234.

The node 222 has been defined in advance to allow the node 222 to receive a vector, e.g., vector 236, at the first input 230. The vector 236 may include a plurality of object references (e.g., object1, object2, object3). The node 222 may determine the “name” property of each object reference in the vector 236 to provide a vector of results (e.g., vector 238) which may be supplied by the output 234 of the node 222. For example, the node 222 may retrieve the “name” property (e.g., “apple”) of the first object reference (e.g., object1) in the vector 236 to determine the first “name” in the vector of results 238. The node 222 may retrieve the “name” property (e.g., “banana”) of the second reference (e.g., object2) in the vector 236 to determine the second “name” in the vector of results 238. The node 222 may retrieve the “name” property (e.g., “pear”) of the third reference (e.g., object3) in the vector 236 to determine the third “name” in the vector of results 238.

Notably, no current dataflow application provides nodes that accept lists of non-numeric values. It is not the case that such nodes could not be defined, but the semantics of current dataflow languages make such definitions less useful.

As further described hereinafter, in some embodiments, a node may be a property defining node.

FIG. 2C is a dataflow diagram 240 showing an example of dataflow program semantics that may be used in defining a dataflow network, in accordance with some embodiments. Referring to FIG. 2C, the dataflow diagram 240 includes a node 242 and two edges 244, 246. The node 242 has two inputs 250, 252. The first edge 244 is connected to the first input 250. The second edge 246 is connected to the second input 252.

The node 242 is a property defining node. For example, the node 242 may be a “color” property defining node, sometimes referred to herein as a set color node that defines the “color” property of an object. In that regard, a reference to an object (e.g., object 1) may be supplied to the first input 250 of the node 242. In accordance with some embodiments, the object may be an internal object and/or an external object. A reference to a color property (e.g., white) may be supplied to the second input 252 of the node 242. The node 242 may define the “color” property of the object (e.g., object 1) supplied to the first input 250 of the node 242, to the reference color (e.g., white) supplied to the second input 252 of the node 242.

As further defined hereinafter, in some embodiments, a property defining node may be defined to allow the node to accept a vector of object references on one or more inputs of the node.

FIG. 2D is a dataflow diagram 260 showing an example of dataflow program semantics that may be used in defining a dataflow network, in accordance with some embodiments. Referring to FIG. 2D, the dataflow diagram 260 includes a node 262 and two edges 264, 266. The node 262 has two inputs 270, 272. The first edge 264 is connected to the first input 270. The second edge 266 is connected to the second input 272.

The node 262 has been defined in advance to allow the node 262 to receive a vector, e.g., vector 276, at the first input 270. The vector 276 may include a plurality of object references (e.g., object1, object2, object3). The node 262 may define the color property of each object reference in the vector 276 to the reference color supplied to second input 272 of the node 262. For example, the node 262 may define the “color” property of the first object reference (e.g., object1) in the vector 276 supplied to first input 270 of the node 262, to the reference color (e.g., white) supplied to the second input 272 of the node 262. The node 262 may define the “color” property of the second object reference (e.g., object2) in the vector 276 supplied to first input 270 of the node 262, to the reference color (e.g., white) supplied to the second input 272 of the node 262. The node 262 may define the “color” property of the third object reference (e.g., object3) in the vector 276 supplied to first input 270 of the node 262, to the reference color (e.g., white) supplied to the second input 272 of the node 262.

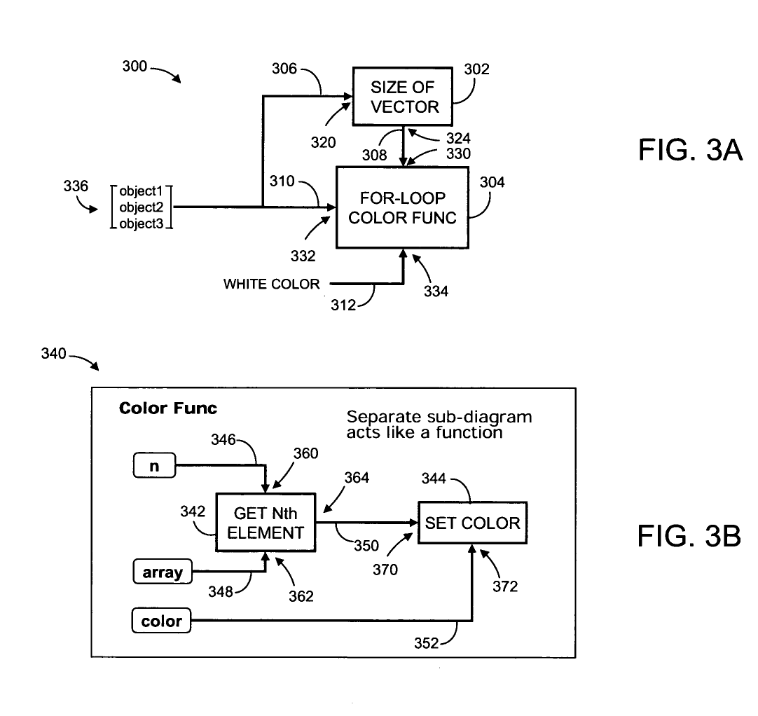

Notably, if a programmer desires loop-like behavior, current dataflow applications require that the programmer define multiple dataflow networks, for example as shown in FIGS. 3A-3B. As further described hereinafter, the networks are joined by including a specially defined node in the parent network (FIG. 3A) that links it to the sub-network (FIG. 3B). More particularly, a for-loop node (FIG. 3A) links to a sub-network (FIG. 3B) where a single instance Set Color node is used. This allows the programmer to use nodes that do not have vector support with vector input, but necessitates more programming effort. Some dataflow languages allow the sub-network to be displayed in the same diagram as the parent network, but the sub-network is always kept segregated as though it were on a separate page. Thus, an arbitrary iteration requires significant programming using multiple dataflow diagrams.

FIGS. 3A-3B are dataflow diagrams showing an example of dataflow program semantics that may be used in defining a dataflow network, in accordance with some embodiments. Referring to FIG. 3A, a dataflow diagram 300 includes two nodes 302, 304. The first node 302 may be a property retrieval node, e.g., a “size of vector” retrieval node. The second node 304 may be a for-loop node.

An array or vector (e.g., vector 336) may be supplied to an input 320 of the first node 302. The vector 336 may include a plurality of object references (e.g., object1, object2, object3). The first node 302 may determine the size of the vector 336, and the size of the vector 336 may be supplied to a first input 330 of the second node 304. The vector (e.g., vector 336) may also be supplied to a second input 332 of the second node 304, and a third input 334 of second node 304 may receive a reference to a color property (e.g., white). The second node 304 may invoke a second or sub dataflow network (e.g., color func), further described hereinafter for FIG. 3B, which may define the color property of each object reference in the array 336 to the reference color supplied to the third input 334 of the node 304.

Referring to FIG. 3B, a second or sub dataflow diagram 340 includes two nodes 342, 344. The first node 342 may be an element retrieval node. The second node 344 may be a property defining node, e.g., a “color” property defining node, which may be the same as and/or similar to the node 242 (FIG. 2C) described hereinabove.

The vector (e.g., vector 336) may be supplied to a first input 362 of the first node 342, a second input 360 of which may receive an index (e.g., n). The first node 342 may determine the indexed element (e.g., the nth element) of the array 336. The indexed element of the array 336 may be supplied to a first input 370 of the second node 344, a second input 372 of which may receive the color property (e.g., white). The second node 344 may define the color property of the indexed element of the array received on the first input 370 of the node 344 to the reference color supplied to the second input 372 of the node 344.

In accordance with some embodiments, a dataflow diagram may include a node that defines (or generates) an iteration context. In some embodiments, a node that defines an iteration context may control (directly and/or indirectly) the number of times that a node within the iteration context is invoked.

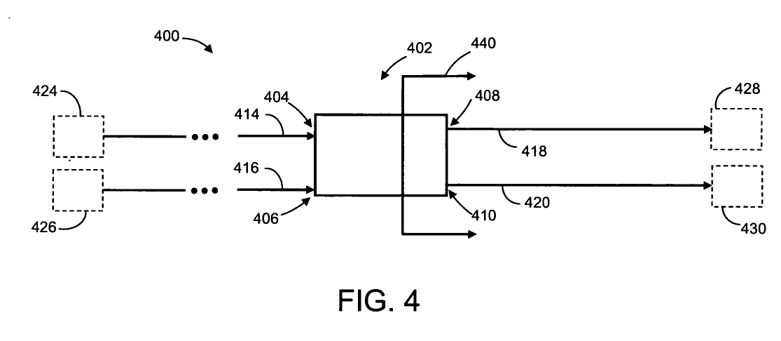

FIG. 4 is a dataflow diagram 400 showing an example of dataflow program semantics that may be used in defining a dataflow network, in accordance with some embodiments. Referring to FIG. 4, in accordance with some embodiments, the dataflow diagram 400 includes a node 402 that defines an iteration context.

The node 402 may have one or more inputs (e.g., two inputs 404, 406) and/or one or more outputs (e.g., two outputs 408, 410). A first edge 414 may connect the first input 404 to an output of a node, e.g., node 424, which may be a source of data for the first input 404. A second edge 416 may connect the second input 406 to an output of a node, e.g., node 426, which may be a source of data for the second input 406. A third edge 418 may connect the first output 408 to an input of a node, e.g., node 428, which may receive data supplied by the first output 408. A fourth edge 420 may connect the second output 410 to an input of a node, e.g., node 430, which may receive data supplied by the second output 410. The node 428 and the node 430 are each within the iteration context defined by the node 402.

A node that defines an iteration context is sometimes denoted herein by a symbol 440.

In accordance with some embodiments, and as further described hereinafter, a node that defines an iteration context may be used in determining whether to execute (or invoke) node(s) that are disposed within the iteration context defined by such node, and/or how many times to execute (or invoke) node(s) that are disposed within the iteration context defined by such node.

Thus, in some embodiments, the node 402 may be used in determining whether to execute (or invoke) node(s), e.g., nodes 428, 430, that are disposed within the iteration context defined by the node 402, and/or how many times to execute (or invoke) nodes, e.g., nodes 428, 430, that are disposed within the iteration context defined by the node 402.

In accordance with some embodiments, a node that defines an iteration context, e.g., node 402, (1) may have any number and/or type of inputs and/or outputs and (2) may define any number and/or type of functions. Thus, a node that defines an iteration context may be defined to (1) receive any amount and/or type of data and/or (2) supply any amount and/or type of data.

In accordance with some embodiments, one type of node that defines an iteration context is referred to herein as a fan out node.

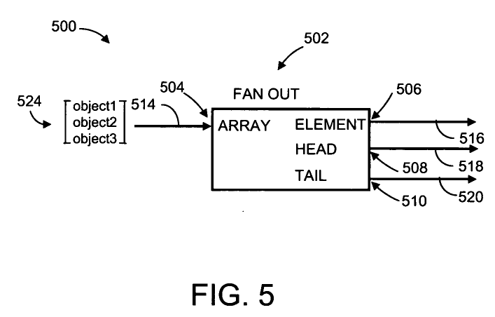

FIG. 5 is a dataflow diagram 500 showing an example of dataflow program semantics that may be used in defining a dataflow network, in accordance with some embodiments. Referring to FIG. 5, the dataflow diagram 500 includes a node 502 that defines an iteration context. In accordance with some embodiments, the node 502 has been defined in advance as a fan out node.

In this embodiment, the node 502 has one input 504 and three outputs 506, 508, 510. A first edge 514 may connect the input 504 to an output of a node (not shown), which may be a source of data for the input 504. A second edge 516 may connect the first output 506 to an input of a node (not shown), which may receive data supplied by the first output 506. A third edge 518 may connect the second output 508 to an input of a node (not shown), which may receive data supplied by the second output 508. A fourth edge 520 may connect the third output 510 to an input of a node (not shown), which may receive data supplied by the third output 510.

In accordance with some embodiments, the fan out node 502 receives an array (or list or vector), e.g., array 524, at the first input 504. The array 524 may include a plurality of elements. The plurality of elements may include any number and/or type of elements. In some embodiments, the elements may be object references (e.g., object1, object2, object3).

In accordance with some embodiments, the fan out node 502 supplies the elements, one at a time, from the first output 506 of the node 502. In accordance with some embodiments, node 502 may output the elements (i.e., present the elements to the output of node 502) one at a time. For example, the first output 506 may initially supply the first element (e.g., object1) of the array 524. Thereafter, the first output 506 may supply the second element (e.g., object2) of the array 524. Thereafter, the first output 506 may supply the third element (e.g., object3) of the array 524.

Thus, for example, if the array has three elements (e.g., object1, object 2, object 3), then nodes in the iteration context defined by node 502 will be executed three times. Specifically, the node 502 outputs the first element (e.g., object1) and the node(s) in the iteration context defined by node 502 are executed a first time. Thereafter, node 502 outputs a second element (e.g., object2) and the node(s) in the iteration context defined by node 502 are executed a second time. Thereafter, node 502 outputs a third element (e.g., object3) and the node(s) in the iteration context defined by node 502 are executed a third time.

Thus, node(s) within an iteration context defined by another node may be executed (or invoked) one time for each element output by such other node. For example, if the node that defines the iteration context has zero elements to output (i.e., no elements to output), then node(s) in the iteration context defined by such node may be executed zero times (i.e., not executed). If the node that defines the iteration context has one element to output, then the node(s) in the iteration context defined by such may be executed one time. If the node that defines the iteration context has a plurality of elements to output, then node(s) in the iteration context defined by such node may be executed a plurality of times, once per element to be output by the node that defines the iteration context.

In accordance with some embodiments, the second output 508 and the third output 510 may each supply a Boolean value. Specifically, if the first output 506 supplies the first element of the array 524, the second output 508 supplies a Boolean value having a “true” state. Otherwise, the second output 508 supplies a Boolean value having a “false” state. If the first output 506 supplies the last element of the array 524, the third output 510 supplies a Boolean value having a “true” state. Otherwise, the third output 510 supplies a Boolean value having a “false” state. In some embodiments, the fan out node 502 may not include the second output 508 and/or the third output 510.

In some embodiments, an iteration context is defined to propagate to all nodes connected to an output of the node that defines (or produces) the iteration context. In some embodiments, the iteration context also propagates to all nodes connected to the outputs of those nodes and so forth. In some embodiments, the propagation halts when there are no more nodes in the chain or the context is retracted by a node.

In accordance with some embodiments, an “iteration context” is a property of a node's definition. Other properties may include, but are not limited to, its name, the number and types of its input nodes, the number and types of its output nodes, the number and types of programmer editable fields, and the code that actually computes the node's output value.

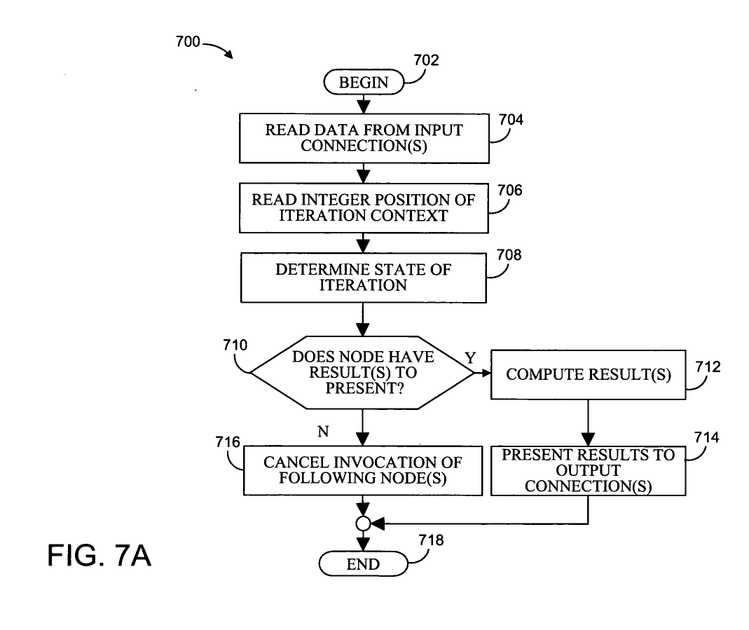

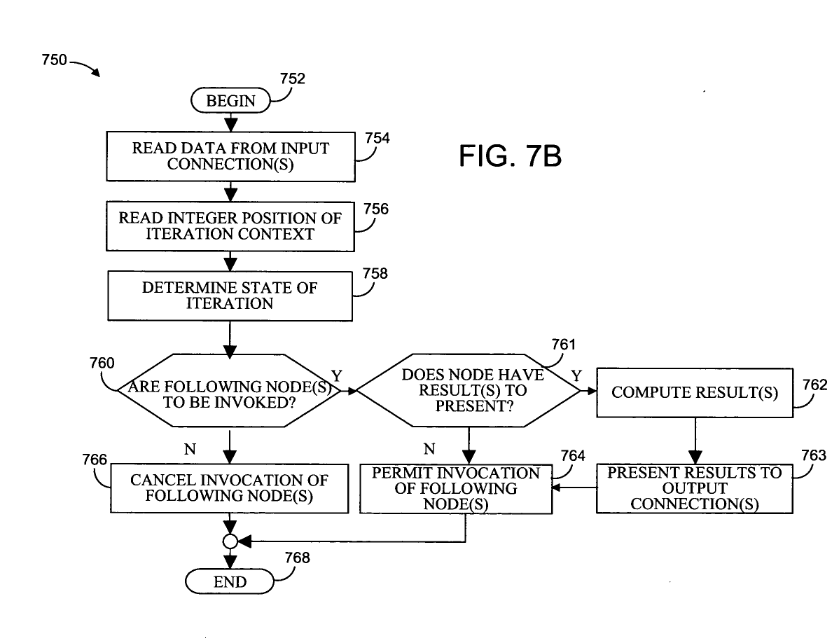

The iteration context maintains an integer state that defines what step in the iteration is currently active. Unlike a for-loop that immediately repeats the execution of subordinate statements, a dataflow node in the present invention evaluates one iteration at a time then exits. Whether the iteration continues or not, the system will determine which nodes to evaluate next. FIG. 7A shows the behavior of a node that defines an iteration context in accordance with some embodiments. As further described hereinafter, along with its normal input, the node reviews the current state of the iteration. This value is provided by the system. The node determines whether or not the system should invoke nodes in its iteration context. In some embodiments, the node is permitted to halt the iteration at any point. If the node continues the iteration, it evaluates the proper result values that it presents to its output connections.

In accordance with some embodiments, nodes that do not define an iteration context act as conventional nodes in a dataflow network. As further described herein, when conventional nodes are invoked by the system, they may, for example, take the values presented to their input connections, perform their calculation, and present the results to their output connections.

However, in accordance with some embodiments, a node that defines an iteration context will use the state of the iteration to inform the system how to modify its behavior.

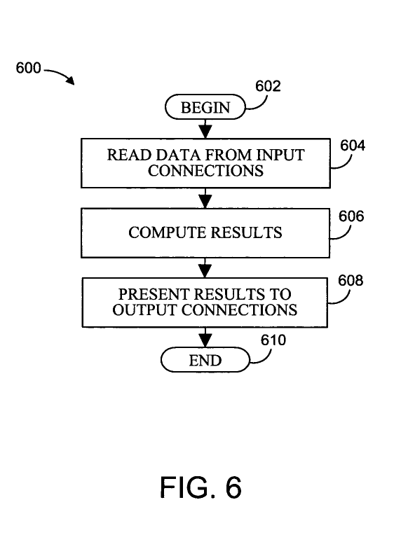

FIG. 6 is a flow chart 600 of a method according to some embodiments. In accordance with some embodiments, the method may be carried out by a node that does not define an iteration context. The method begins at 602. At 604, data is read from input connections of a node. At 606, results are computed. The results may be based at least in part on the data read from the input connections. At 608, the results are presented to output connections of the node. The method ends at 610.

FIG. 7A is a flow chart 700 of a method according to some embodiments. In accordance with some embodiments, the method may be carried out by a node that defines an iteration context. The method begins at 702. At 704, the method may include reading data from one or more input connections of a node that defines an iteration context. At 706, the method may further include reading an integer position of the iteration context. At 708, the method may further include determining a state of iteration. At 710, the method may further include determining whether the node has data to present. In accordance with some embodiments, the data may be of any type and/or form. In accordance with some embodiments, determining whether the node has data to present may comprise determining whether the node has results to present. If the node has results to present, at 712, the method may further include computing results. In some embodiments, the results may be based at least in part on the data read from the input connections. At 714, the method may include presenting data to one or more output connections of the node. In some embodiments, presenting data to one or more output connections of the node may comprise presenting results to one or more output connections of the node. At 716, the method may further include canceling invocation of following nodes if it is determined at 710 that the node does not have data to present. In some embodiments, canceling invocation of following nodes occurs if it is determined that the node does not have results to present. In accordance with some embodiments, a node that defines an iteration context may control the number of times that it and/or node(s) in the iteration context are invoked. The method ends at 718.

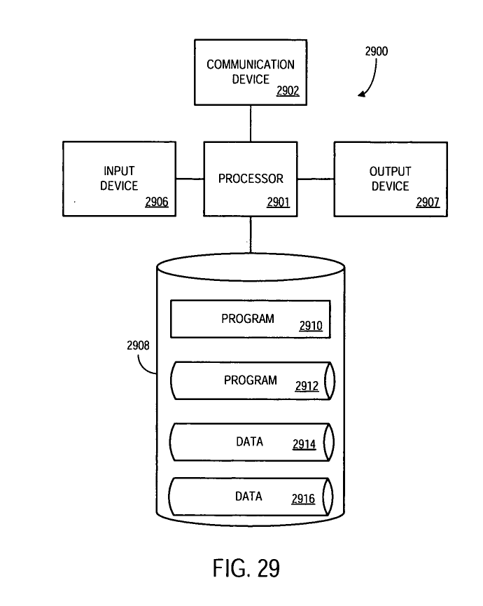

The method 700 is not limited to the order shown in the flow chart. Rather, embodiments of the method 700 may be performed in any order that is practicable. For that matter, unless stated otherwise, any method disclosed herein may be performed in any order that is practicable. Moreover, unless stated otherwise, the method 700 may be performed in any manner. In that regard, in some embodiments, one or more portions of one or more methods disclosed herein may be performed by a processing system. As further described hereinafter, in some embodiments, a processing system may comprise hardware, software (including microcode), firmware, or any combination thereof. In some embodiments, one or more portions of one or more methods disclosed herein may be performed by a processing system such as the processing system in FIG. 29.

In some embodiments, the determination as to whether to invoke the node(s) within an iteration context may not be based solely, and/or even in part, on whether the node that defines the iteration context has data to present.

In some embodiments, the determination as to whether to invoke the node(s) within an iteration context may or may not be based on whether the node that defines the iteration context has data to present. In that regard, in some embodiments, an iteration context defining node, e.g., node 402 (FIG. 4), has an input, e.g., input 404, that receives data (e.g., a value) indicating a number of times to invoke node(s) within the iteration context defined by such node. In such embodiments, the iteration context defining node may or may not have data to present during such iterations. For example, if the context defining node, e.g., node 402, receives a value equal to three, then node(s) in the iteration context defined by node 402 may be executed three times. Specifically, the node(s) in the iteration context defined by node 402 may be executed a first time (regardless of whether the node 402 has data to present). Thereafter, node(s) in the iteration context defined by node 402 may be executed a second time (regardless of whether the node 402 has data to present). Thereafter, node(s) in the iteration context defined by node 402 may be executed a third time (regardless of whether the node 402 has data to present).

FIG. 7B is a flow chart 750 of a method in accordance with some embodiments, in which the determination as to whether to invoke the node(s) within an iteration context may or may not be based on whether the node that defines the iteration context has data to present. In accordance with some embodiments, the method may be carried out by a node that defines an iteration context. The method begins at 752. At 754, the method may include reading data from one or more input connections of a node that defines an iteration context. At 756, the method may further include reading an integer position of the iteration context. At 758, the method may further include determining a state of iteration. At 760, the method may further include determining whether the following node(s) are to be invoked. In accordance with some embodiments, determining whether following node(s) are to be invoked may include determining whether one or more criteria is satisfied. In some embodiments, determining whether one or more criteria is satisfied may include determining whether the following node(s) have been invoked a desired number of times. If the following node(s) are determined at 760 to be invoked, then at 761, the method may further include determining whether the node has data to present. In accordance with some embodiments, determining at 761 whether the node has data to present may comprise determining whether the node has results to present. If the node has results to present, at 762, the method may further include computing results. In some embodiments, the results may be based at least in part on the data read from the one or more input connections. At 763, the method may include presenting data to one or more output connections of the node. In some embodiments, presenting data to one or more output connections of the node may comprise presenting results to one or more output connections of the node. After 763 or after it is determined at 761 that the node does not have data (in some embodiments, results) to present, at 764, the method may further include permitting invocation of the following node(s). At 766, the method may further include canceling invocation of following nodes if it is determined, at 760, that the node does not want the following node(s) to be invoked. In accordance with some embodiments, a node that defines an iteration context may control the number of times that it and/or node(s) in the iteration context are invoked. The method ends at 768.

In accordance with some embodiments, a fan out node may be employed in situation (s) where an unknown number of objects may need to be manipulated. In accordance with some embodiments, one situation where an unknown number of objects may need to be manipulated may occur when a dataflow language is deployed in conjunction with a separate system of objects. In accordance with some embodiments, in some separate systems, objects can be created and destroyed arbitrarily and can change configuration dynamically, so a dataflow network that operates on such a system must be able to handle that dynamism.

In accordance with some embodiments, a dataflow network may be used in association with a simulation. In accordance with some embodiments, a simulation may be one type of situation where an unknown number of objects may need to be manipulated. In accordance with some embodiments, during execution of a simulation, objects can be created and destroyed arbitrarily and can change configuration dynamically, so a dataflow network that operates on such a system must be able to handle that dynamism.

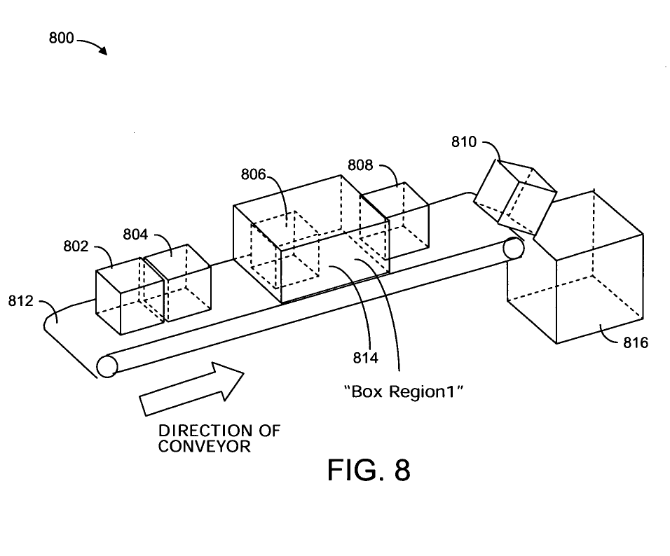

FIG. 8 is a representation showing an example of a simulation 800 that may be used in association with a dataflow network, in accordance with some embodiments. Referring to FIG. 8, the simulation 800 includes an object maker 802 that dynamically creates box objects, e.g., box objects 804, 806, 808, 810, which are put into the simulation. The box objects travel on a conveyor belt 812 and through an object detector 814. The object detector 814 may define a region, sometimes referred to herein as “Box Region 1”. When a box object, e.g., box object 810, reaches the end of the conveyor belt 812, the box object falls off of the conveyor belt 812 and is deleted by an object remover 816.

In accordance with some embodiments, the simulation may represent an assembly line that moves boxes through a painting machine. The conveyor belt may be used to the move box objects through a region. The object detector in the simulation may represent a place where paint is applied to the boxes. The object maker may represent a source of boxes from some previous stage of the assembly process, such as a person putting the boxes on the line. The object remover may represent the destination of the boxes and may delete the boxes from the simulation. In the real world, the boxes might continue to a subsequent step in a process.

As stated above, in accordance with some embodiments, a dataflow network may be used in association with a simulation. In that regard, in some embodiments, a dataflow network may be useful for, but is not limited to, programming the behavior of one or more aspects of a simulation and/or to perform operations on one or more objects in a simulation.

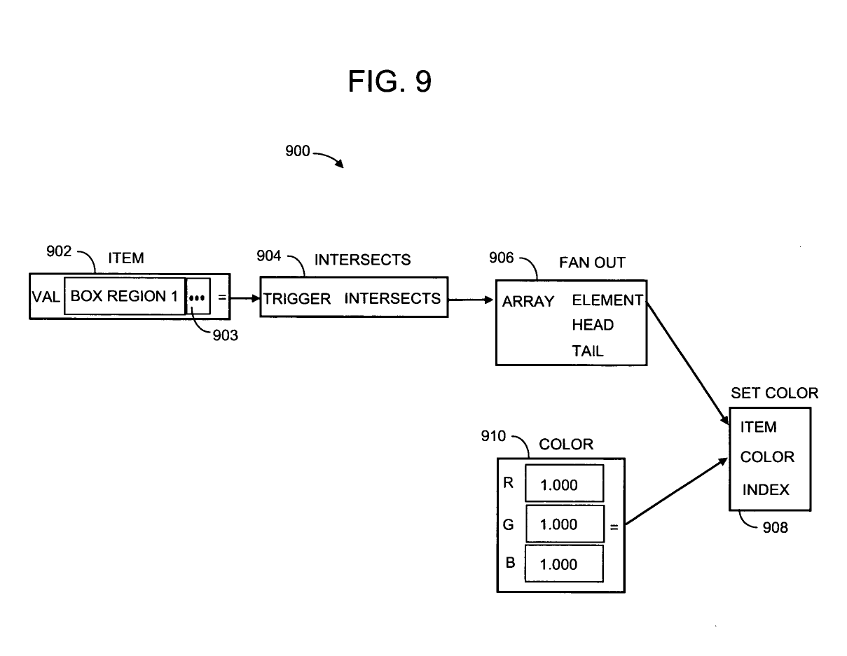

FIG. 9 is a dataflow diagram 900 defining one type of dataflow network that may be used in association with the simulation 800 (FIG. 8). In accordance with some embodiments, the dataflow diagram 900 defines a dataflow network that may be used to change the color of box objects in the region defined by the object detector 814 (FIG. 8).

Because the boxes are dynamically created, the system may be designed to refer to the boxes indirectly. Furthermore, in accordance with some embodiments, a behavior may need to affect multiple boxes at the same time and may not always be able to refer to any given box. Such operation would be difficult to implement using prior dataflow systems, because of the limits of their semantics.

Referring to FIG. 9, the dataflow network has five nodes 902, 904, 906, 908 and 910. The first node 902 is an item node that is used to provide a reference to a known object in the simulation. In accordance with some embodiments, the first node 902 includes a reference to the region defined by the object detector 814 (FIG. 8), e.g., “Box Region 1”. An object reference value corresponding to the object detector 814 (FIG. 8) is retrieved from the simulation and presented as an output of the node 902.

As stated above, in some embodiments, a user may utilize a graphical user interface to define one or more portions of a dataflow diagram and/or a dataflow network. In that regard, in some embodiments, one or more nodes may include one or more graphical editing tools to assist the user in that respect. For example, the first node 902 may include a button 903. The user may mouse-click and/or otherwise select the button 903 to initiate a drop down menu and/or dialogue box to help the user specify a reference to a region, e.g., “Box Region 1”.

The object reference value from node 902 is supplied to an input of the second node 904. The second node 904 is an intersect node that performs an operation to retrieve object references that identify objects in the simulation that intersect the volume of the object detector. In accordance with some embodiments, the second node 904 takes a single object (of detector type which is also called a “trigger”) as input and returns a list of object references as its result.

Since the conveyor belt 812 (FIG. 8) moves box objects through the object detector's volume (or region), the node 904 will return a list of object references corresponding to the box objects that intersect the volume (or region) of the object detector 814. In accordance with some embodiments, the output of the second node 904 supplies the list of object references in the form of an array.

It should be noted that the number of object references returned by the second node 904 depends on the current situation within the simulation. For example, there may be one box that intersects the detector's volume, there may be many boxes that intersect the detector's volume, or there may be no boxes that intersect the detector's volume. Dataflow languages that require fixed sized data types are unable to handle this type of situation.

The array of object references is supplied to an input of the third node 906. The third node 906 may be a fan out node that defines an iteration context. In some embodiments, the fan out node 906 may be the same as and/or similar to the fan out node 502 (FIG. 5). In accordance with some embodiments, the fan out node 906 takes in a list or array of object references and presents them, one at a time, to its output.

The object references from the fan out node 906 are supplied, one at a time, to an input of a fourth node 908. The fourth node 908 is a set color node that defines the “color” property of an object. In accordance with some embodiments, the node 908 takes an object reference and a color value as its parameters and sets or changes the object's color property in accordance with the color value. In some embodiments, for example, the set color node receives a color value (e.g., a color value corresponding to white) from node 910, and sets the object's color property equal to the received color value, e.g., the color value corresponding to white.

Thus, in some embodiments, a fan out node may make it possible to use a node that takes an object parameter of single object type (not a list type) and use it as though it is a node that takes an object parameter of list type. For example, in accordance with some embodiments, a fan out node may make it possible to use a node such as, for example, node 242 (FIG. 2C) as though it is a node such as for example, node 262 (FIG. 2D). This is not limited to a node that sets color, but could be applicable to other types of nodes. For example, in accordance with some embodiments, a fan out node may make it possible to use a node such as, for example, node 202 (FIG. 2A) as though it is a node such as for example, node 222 (FIG. 2B).

Other dataflow networks may also be employed. In some embodiments, one or more of the dataflow networks disclosed herein may be employed with fewer than all features disclosed herein for such dataflow network and/or with one or more features in addition to those disclosed herein for such network. For that matter, in some embodiments, one or more of one or more types of nodes disclosed herein may be employed with fewer than all features disclosed herein for such node and/or with one or more features in addition to those disclosed herein for such node. Furthermore in some embodiments, dataflow network may be employed without a simulation.

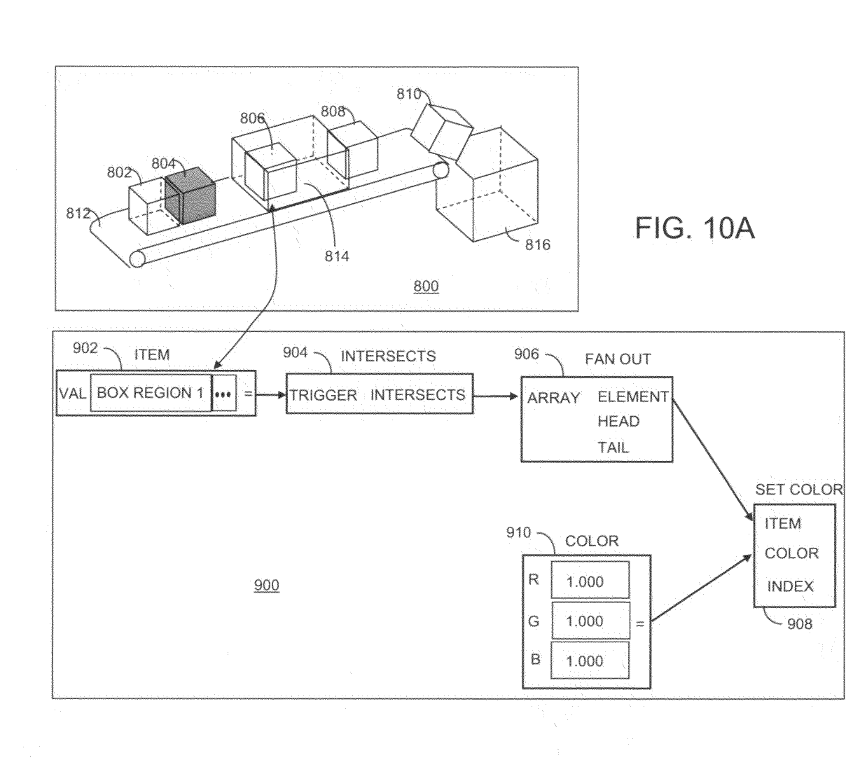

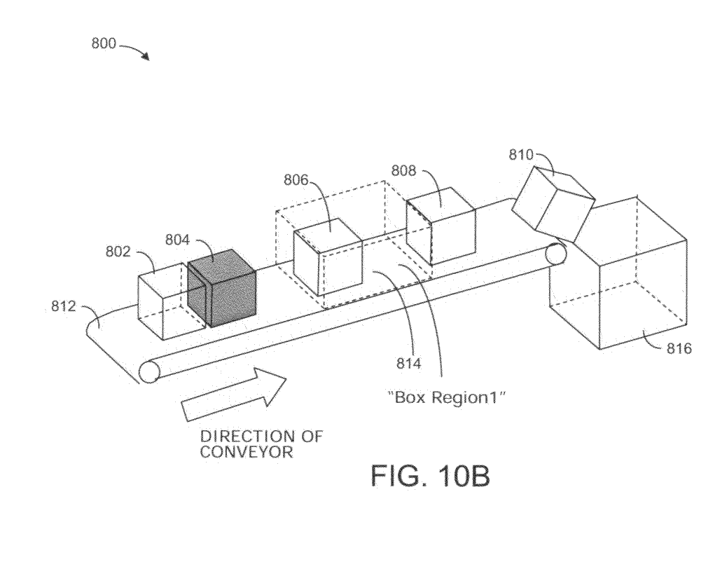

FIG. 10A is a diagram that shows the simulation 800 (FIG. 8) in association with the dataflow diagram 900 (FIG. 9). In accordance with some embodiments, when the dataflow program is used to review and/or control an external process, the data of the process may be held in objects that can be discovered by the dataflow. In accordance with some embodiments, objects in the simulation 800 may represent an external state. The dataflow diagram 900 may define the behavior of one or more objects in such external state.

FIG. 10B is a representation of the operation of the simulation 800 (FIG. 8) in association with the dataflow diagram 900 representing the dataflow network of FIG. 9. Referring to FIG. 10B, in accordance with the description hereinabove, it can be seen that boxes entering the region defined by the object detector have their color set to white.

It should be noted that, given a reference to an object, there are many possible operations that a user may want to perform on it and/or many possible functions that a user may want to apply to it. Although the dataflow diagram 900 defines a dataflow network that may be used to change the color of box objects in the region defined by the object detector 814 (FIG. 8), in some embodiments, one or more other operations and/or one or more other functions may be applied in lieu of or in addition thereto any of the possible operations and/or possible functions described herein.

In accordance with some embodiments, a dataflow node can be defined to retract an iteration context. In accordance with some embodiments, and as further described hereinafter, the iteration context retracted by such node is the iteration context defined by, or applied to, nodes connected or coupled to the input of the node that retracts the iteration context. In accordance with some embodiments, any nodes that are connected to the output of a node that retracts an iteration context may use a prior iteration context.

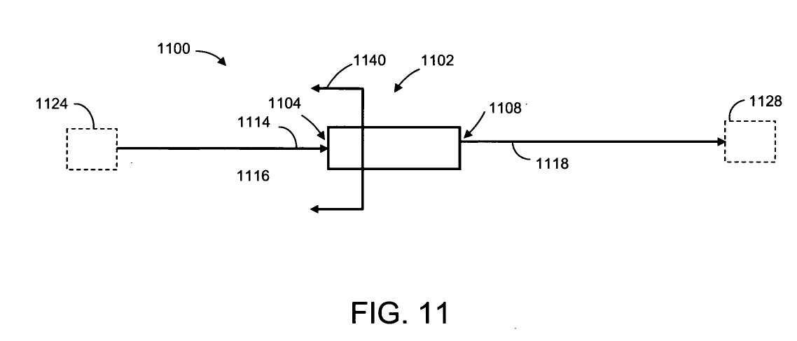

FIG. 11 is a dataflow diagram 1100 showing an example of dataflow program semantics that may be used in defining a dataflow network, in accordance with some embodiments. Referring to FIG. 11, in accordance with some embodiments, the dataflow diagram 1100 includes a node 1102 that retracts (or repeals) an iteration context.

The node 1102 may have one or more inputs, e.g., input 1104, and/or one or more outputs, e.g., output 1108. A first edge 1114 may connect the first input 1104 to an output of a node, e.g., node 1124, which may be a source of data for the first input 1104. A second edge 1118 may connect the first output 1108 to an input of a node, e.g., node 1128, which may receive data supplied by the first output 1108.

In accordance with some embodiments, a node, e.g., node 1124, connected to the first input 1104 of node 1102 may be in and/or may define an iteration context and the node 1102 may retract that iteration context. In accordance with some embodiments, a node, e.g., node 1128, connected to the first output 1108 of node 1102 may be in an iteration context defined previous to the iteration context revoked by the node 1102, if any, or in no iteration context.

A node that retracts an iteration context is sometimes denoted herein by a symbol 1140.

In accordance with some embodiments, a node that retracts an iteration context, e.g., node 1102, (1) may have any number and/or type of inputs and/or outputs and (2) may define any number and/or type of functions. Thus, a node that retracts an iteration context may be defined to (1) receive any amount and/or type of data and/or (2) supply any amount and/or type of data.

In accordance with some embodiments, one example of a node that retracts an iteration context is sometimes referred to hereinafter as a “fan-in” node. In accordance with some embodiments, and as further described hereinafter, a fan-in node may take single values presented by a prior iteration context (such as a fan-out) and collects them into a list. The collected list may then be produced as the output of the node. In accordance with some embodiments, employing a fan-in node in a position where there is no iteration context is allowed but may or may not be useful.

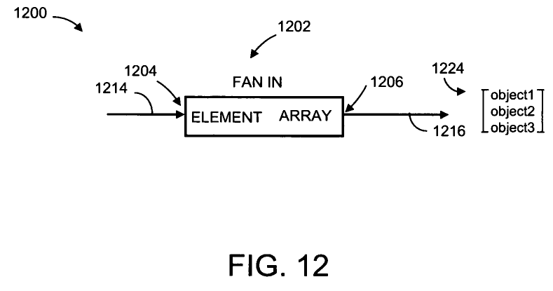

FIG. 12 is a dataflow diagram 1200 showing an example of dataflow program semantics that may be used in defining a dataflow network, in accordance with some embodiments. Referring to FIG. 12, the dataflow diagram 1200 includes a node 1202 that retracts an iteration context. In accordance with some embodiments, the node 1202 has been defined in advance as a fan in node.

In this embodiment, the node 1202 has one input 1204 and one output 1206. A first edge 1214 may connect the input 1204 to an output of a node (not shown), which may be a source of data for the input 1204. A second edge 1216 may connect the first output 1206 to an input of a node (not shown), which may receive data supplied by the first output 1206.

In accordance with some embodiments, the fan in node 1202 receives a number of elements and combines the elements into an array, e.g., array 1224, which may be supplied from the first output 1206 of the node 1202. The number of elements may include any number and/or type of elements. In some embodiments, the elements may be object references (e.g., object1, object2, object3). In some embodiments, the elements may comprise elements from a fan out operation and/or evaluation.

In accordance with some embodiments, a node revoking an iteration context may be treated as being within the iteration context being revoked. In that regard, if the node that defines the iteration context outputs elements one at a time, the node revoking the iteration context may be executed (or invoked) one time for each element output by the node that defines the iteration context. For example, if the node that defines the iteration context has zero elements to output (i.e., no elements to output), then the node revoking the iteration context may be executed zero times (i.e., not executed). If the node that defines the iteration context has one element to output, then the node revoking the iteration context may be executed one time. If the node that defines the iteration context has a plurality of elements to output, then the node revoking the iteration context may be executed a plurality of times, once for element to be output by the node that defines the iteration context.

In accordance with some embodiments, if a node retracts an iteration context, the iteration context for successive (or following) nodes reverts to the prior iteration context, i.e., the iteration context defined previous to the iteration context of the node that defined the retracted iteration context. If there was no prior iteration context, then the successive nodes act as nodes having no iteration context. A new iteration context defined by a node replaces the current iteration context for following nodes. Thus, a given node has only one iteration context. When an iteration context is replaced by a new iteration context, the new iteration context is considered to be “nested” within the previous iteration context.

In accordance with some embodiments, a fan out node may be used in association with a simulation.

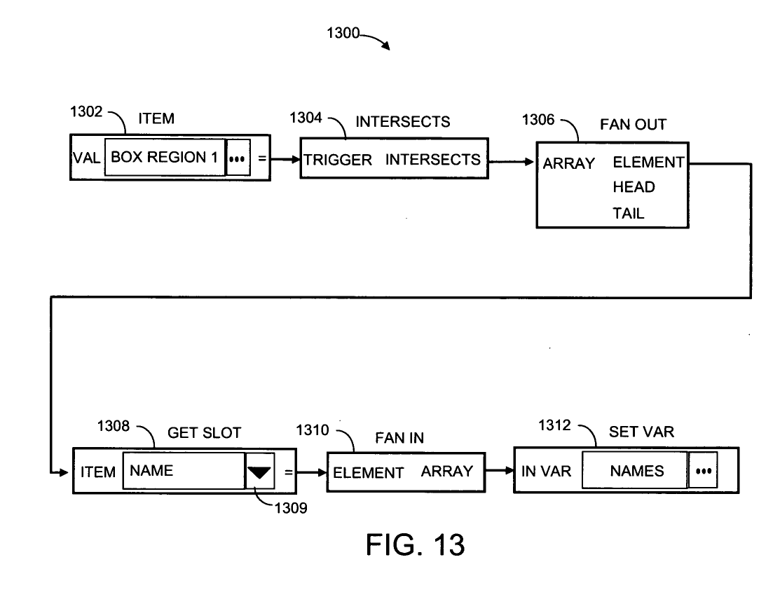

FIG. 13 is a dataflow diagram 1300 defining one type of dataflow network that may be used in association with the simulation 800 (FIG. 8). In accordance with some embodiments, the dataflow diagram 1300 defines a dataflow network that may be used to generate a list of all names of boxes that are in “Box Region 1” defined by the object detector 814 (FIG. 8).

Referring to FIG. 13, the dataflow network has six nodes 1302, 1304, 1306, 1308, 1310 and 1312. The first node 1302, the second node 1304 and the third node 1306 are identical to the first node 902 (FIG. 9), the second node 904 (FIG. 9) and the third node 906 (FIG. 9), respectively. Thus, the first node 1302 is an item node that is used to provide a reference to a known object in the simulation. The object reference value from node 1302 is supplied to an input of the second node 1304, which performs an operation to retrieve object references that identify objects in the simulation that intersect the volume of the object detector.

As stated above, since the conveyor belt 812 (FIG. 8) moves box objects through the object detector's volume (or region), the node 1304 will return a list of object references corresponding to the box objects that intersect the volume (or region) of the object detector 814. In accordance with some embodiments, the output of the second node 1304 supplies the list of object references in the form of an array.

The array of object references is supplied to an input of the third node 1306, which may be a fan out node that defines an iteration context. In accordance with some embodiments, the fan out node 1406 presents the object references, one at a time, to its output.

The object references from the fan out node 1306 are supplied, one at a time, to an input of a fourth node 1308. The fourth node 1308 is a get slot node that is used to provide a “name” property associated with an object reference. In that regard, fourth node 1308 may determine the “name” property (e.g., “red box 1”) of the object reference supplied to the input of the fourth node 1308, and the “name” property may be supplied by the output of the node 1308. Node 1308 may function like node 202 (FIG. 2A) described hereinbefore.

As stated above, in some embodiments, a user may utilize a graphical user interface to define one or more portions of a dataflow diagram and/or a dataflow network. In that regard, the fourth node 1308 may include a button 1309. The user may mouse-click and/or otherwise select the button 1309 to initiate a drop down menu and/or dialogue box to help the user specify a desired property (e.g., “NAME”) associated with the object reference.

The “name” property for the object references is supplied, one at a time, to an input of a fifth node 1310. The fifth node 1310 may be fan in node, which retracts an iteration context. In some embodiments, the fan in node 1310 may be the same as and/or similar to the fan in node 1202 (FIG. 12). In accordance with some embodiments, the fan in node 1310 takes in a number of elements and combines the elements into an array, which may be supplied from the output of the node 1310.

The array from the fifth node 1310 is supplied to an input of the sixth node 1312. The sixth node 1312 is a set var node that is used to store the list of all names of all objects in “Box Region 1”. In accordance with some embodiments, the sixth node 1312 may reference external variable “names” whose type is an array of strings. In some embodiments, the set var node may store the list of all names in a global variable.

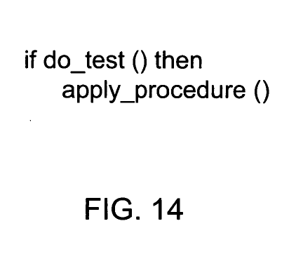

The iteration context technique can be used for tasks other than list processing. For example, a common task in programming is to select which code to run based on a conditional expression. In a standard programming language, this is performed by an if-then statement as shown in FIG. 14. In the standard programming language, the operation of the if-then statement is as follows. If the test function is true, the procedure is executed. If the test function is not true, the procedure is not executed at all.

In accordance with some embodiments, one can perform the equivalent operation in a dataflow program by using another type of node that defines an iteration context. Such a node is sometimes referred to hereinafter as a guard node.

As further described hereinafter, in some embodiments, a guard node takes a Boolean argument and a second element (e.g., an arbitrary value) as input. If the Boolean argument evaluates to true or satisfies other test criteria, the second element is passed onto the output for further computation by successive nodes. If the Boolean argument evaluates to false or satisfies other test criteria, then the second element is not passed on and the successive nodes are not evaluated at all.

In accordance with some embodiments, the semantics of a guard node may be implemented using a node that defines an iteration context. In that regard, in some embodiments, when the condition argument is true or satisfies other test criteria, the node activates successive nodes as though it were processing a list with one element. The successive nodes may be activated one time. When the argument is false or satisfies test criteria, the node behaves as though it was processing an empty list and successive nodes are not activated at all.

Notably, the ability to perform no evaluation is absent from other dataflow languages.

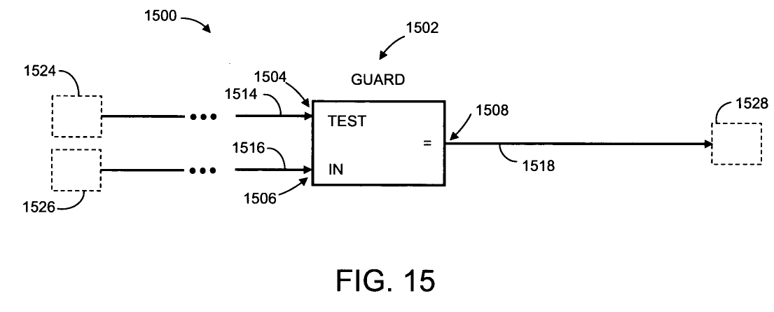

FIG. 15 is a dataflow diagram 1500 showing an example of dataflow program semantics that may be used in defining a dataflow network, in accordance with some embodiments. Referring to FIG. 15, the dataflow diagram 1500 includes a node 1502 that has been defined in advance as a guard node.

In this embodiment, the guard node 1502 has two inputs 1504, 1506 and one output 1508. A first edge 1514 may connect the first input 1504 to an output of a node (e.g., 1524) which may be a source of data for the first input 1504. A second edge 1516 may connect the second input 1506 to an output of a node, e.g., 1526, which may be a source of data for the second input 1506. A third edge 1518 may connect the first output 1508 to an input of a node (e.g., 1528) which may receive data supplied by the first output 1508.

In accordance with some embodiments, the guard node 1502 may receive a Boolean value at the first input 1504. The Boolean value may be of any type and/or form. In some embodiments, the Boolean value may comprise a logic “true” or a logic “false”. The guard node 1502 further receives an element at the second input 1506. In some embodiments, the element may be of any type and/or form.

In accordance with some embodiments, the guard node 1502 passes the element to the first output 1508 if the Boolean value has a “true” state or satisfies other test criteria. The element may thereafter be supplied by the first output 1508. If the Boolean value does not satisfy the test criteria, the guard node 1502 requests that its iteration context be halted and/or no element is passed to the first output 1508. Thus, if the Boolean value does not satisfy the test criteria, the first output 1508 does not supply any element or elements to node 1528.

As stated above, node(s) within an iteration context defined by another node may be executed (or invoked) one time for each element output by such other node. In that regard, in accordance with some embodiments, a node or nodes within the iteration context defined by the guard node 1502 is/are executed (or invoked) if the Boolean value satisfies the test criteria. Otherwise, a node or nodes within the iteration context defined by the guard node 1502 is/are not executed.

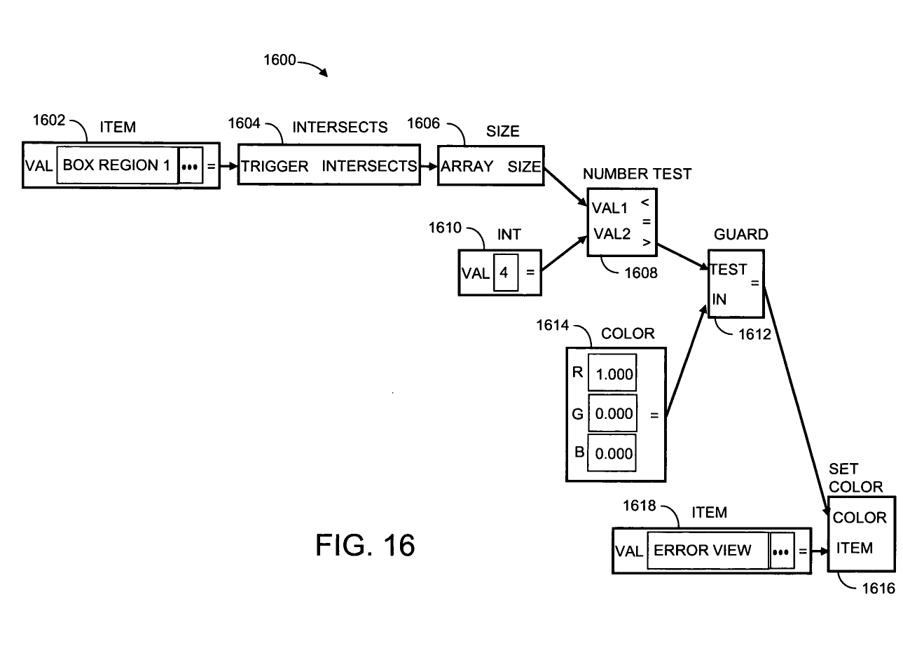

FIG. 16 is a dataflow diagram 1600 defining one type of dataflow network that may be used in association with the simulation 800 (FIG. 8). In accordance with some embodiments, the dataflow diagram 1600 defines a dataflow network that may be used to count the number of boxes that are in “Box Region 1” defined by the object detector 814 (FIG. 8) and set an object's color if the number exceeds four.

In accordance with some embodiments, the dataflow program 1600 may be used in testing for and/or identifying an error condition in the simulation 800 (FIG. 8). In accordance with some embodiments, the dataflow program 1600 may be used to set the color of an object to red if the number of boxes in the region of the object detector 814 (FIG. 8) exceeds four boxes. The color of the object may be unaffected if the number of boxes in the region of the object detector 814 (FIG. 8) does not exceed four boxes.

Referring to FIG. 16, the dataflow network has nine nodes 1602, 1604, 1606, 1608, 1610, 1612, 1614, 1616 and 1618. The first node 1602 and the second node 1604 are identical to the first node 902 (FIG. 9) and the second node 904, respectively. Thus, the first node 1602 is an item node that is used to provide a reference to a known object in the simulation. The object reference value from node 1602 is supplied to an input of the second node 1604, which performs an operation to retrieve object references that identify objects in the simulation that intersect the volume of the object detector.

As stated above, since the conveyor belt 812 (FIG. 8) moves box objects through the object detector's volume (or region), the node 1604 will return a list object references corresponding to the box objects that intersect the volume (or region) of the object detector 814. In accordance with some embodiments, the output of the second node 1604 supplies the list of object references in the form of an array.

The array of object references is supplied to an input of the third node 1606. The third node 1606 is a size node, an output of which provides a value corresponding to a size of the array supplied to the input of the node 1606.

The value supplied by the third node 1606 is supplied to a first input of the fourth node 1608, a second input of which receives a value from the fifth node 1610. The fourth node 1608 is a number test node, which takes the two input values and can supply three Boolean values (e.g., <, =, >). One of the Boolean values (e.g., >) has a “true” state if the value supplied by node 1606 to the first input of the fourth node 1608 is greater than the value supplied from node 1610 to the second input of the fourth node 1608.

Such Boolean value from the fourth node 1608 is supplied to a first input of the sixth node 1612, a second input of which receives a color value (e.g., red) from the seventh node 1614. In some embodiments, the sixth node 1612 may be the same as and/or similar to the guard node 1502 (FIG. 15). In accordance with some embodiments, the guard node 1612 passes the color value (e.g., red) to an output of the guard node 1612 if the Boolean value has a “true” state or satisfies other test criteria. Otherwise, no element is supplied by the output of the guard node 1612 and/or the guarded node 1616 is not executed.

If the sixth node 1612 supplies a color value, such color value is supplied to the eighth node 1616. The eighth node 1616 is a set color node that is within the iteration context defined by the sixth node 1612.

As stated above, node(s) within an iteration context defined by another node may be executed (or invoked) one time for each element output by such other node. For example, if the node that defines the iteration context has zero elements to output (i.e., no elements to output), then node(s) in the iteration context defined by such node may be executed zero times (i.e., not executed). If the node that defines the iteration context has one element to output, then the node(s) in the iteration context defined by such may be executed one time.

In that regard, in accordance with some embodiments, the eighth node 1616 is executed (or invoked) if the Boolean value satisfies the test criteria such that the sixth node 1612 supplies the color value (e.g., red). Otherwise, the sixth node 1612 does not supply a value and the eighth node 1616 is not executed.

The set color node 1616 may be the same as and/or similar to the set color node 908 (FIG. 9). The set color node 1616 has a second input that receives an object reference from the ninth node 1618. In some embodiments, the object reference corresponds to an object named “error view” in the simulation. In some embodiments, the object named “error view” is a human machine interface, e.g., a light or LED. If executed, the set color node 1616 changes the color property of the object named “error view” in accordance with the color value (e.g., red) supplied to the second input of the set color node 1616.

In accordance with some embodiments, using the guard node 1612 ensures that the set color node 1616 is not executed at all if a condition is not met, i.e., if the number of boxes in the region of the object detector 814 exceeds four boxes in this example.

In accordance with some embodiments, a node may retract an iteration context and define an iteration context. In accordance with some embodiments, if a node retracts an iteration context and defines an iteration context, the node may retract the incoming iteration context and define a new iteration context for nodes connected to its outputs. In accordance with some embodiments, the opposite case may not be useful.

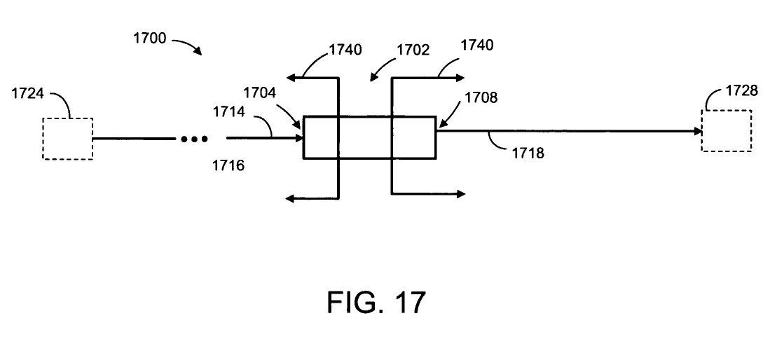

FIG. 17 is a dataflow diagram 1700 showing an example of dataflow program semantics that may be used in defining a dataflow network, in accordance with some embodiments. Referring to FIG. 17, the dataflow diagram 1700 includes a node 1702 that retracts an iteration context and defines an iteration context.

In this embodiment, the node 1702 has one input 1704 and one output 1708. A first edge 1714 may connect the input 1704 to an output of a node, e.g., node 1724, which may be a source of data for the input 1704. A second edge 1718 may connect the first output 1708 to an input of a node, e.g., node 1728, which may receive data supplied by the output 1708.

In accordance with some embodiments, the node 1702 retracts the incoming iteration context and defines a new iteration context for nodes (e.g., node 1728) connected to the output of the node 1702.

As stated above, in some embodiments, a node's input connection may be attached to another's output connection.

In some embodiments an output of a node can be connected to several inputs but each input of a node can only be connected to a single output.

Some embodiments may prohibit inappropriate mixing of iteration contexts. Two iteration contexts are mixed if they both propagate to input connections of the same node. Since a node can only be subjected to the iterations of a single context, having two or more independent contexts propagate to a node results in an ambiguous situation. It is permissible, however, for a context to mix with a prior context in which it is nested. In this case, the node with mixed inputs uses the most deeply nested iteration context as its context and there is no ambiguity.

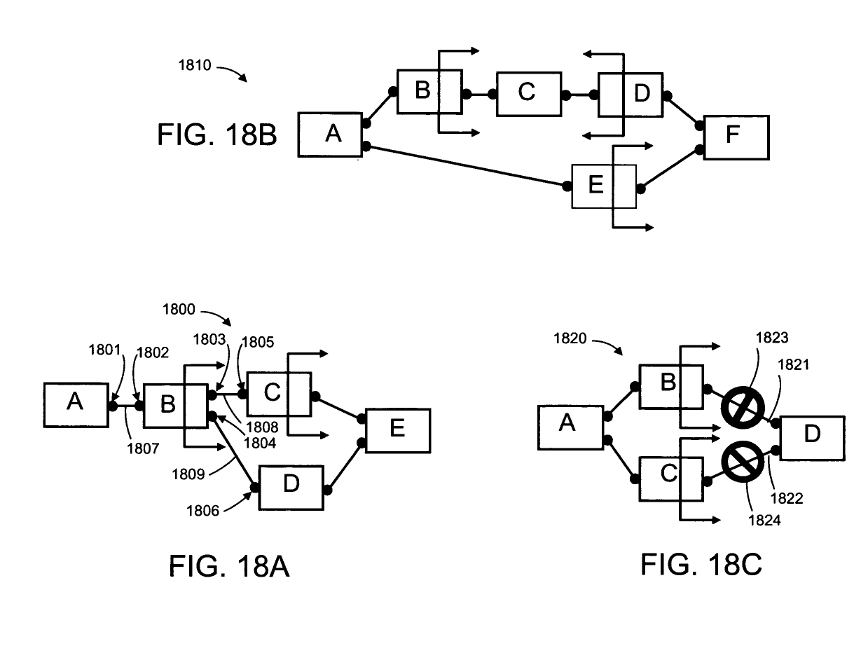

In accordance with some embodiments, and as further described hereinafter, a node may be allowed to be joined to contexts that are nested (FIG. 18A) or when the result of repealing a context is nested (FIG. 18B), but a node may not be allowed to be joined to two or more iteration contexts that are not nested (FIG. 18C).

FIG. 18A is a dataflow diagram 1800 showing an example of dataflow program semantics that may be used in defining a dataflow network, in accordance with some embodiments. Referring to FIG. 18A, the dataflow diagram 1800 includes nodes A-E. Node B defines an iteration context. Nodes C and D are in the iteration context defined by node B. Node C also defines an iteration context. The iteration context defined by node C is nested within the iteration context defined by node B. Node E is connected to the output of node C and the output of node D. Node E is within the iteration context of node C because node C's iteration context is more deeply nested.

Thus, connections that proceed from nodes defining iteration contexts (e.g., output connection of node C and output connection of node B via node D in FIG. 18A) can be connected to inputs of the same node (e.g., inputs of node E in FIG. 18A) if the iteration contexts are nested.

As stated above, in some embodiments, a user may utilize a graphical user interface to define one or more portions of a dataflow diagram and/or a dataflow network. In that regard, in some embodiments, one or more “bubbles” or other symbols may be used to represent an input or output of a node. For example, in the dataflow diagram 1800, a bubble 1801 represents an output of node A; a bubble 1802 represents an input of node B; bubbles 1803, 1804 represent first and second outputs, respectively, of node B; a bubble 1805 represents the input of node C; a bubble 1806 represents the input of node D; etc. Thus, an edge 1807 connects the output 1801 of node A to the input 1802 of node B. An edge 1808 connects the first output 1803 of node B to the input 1805 of node C. An edge 1809 connects the second output 1804 of node B to the input 1806 of node D. Edges 1807-1809 may or may not include an arrow that indicates a direction of “data flow”.

In some embodiments, a user may mouse-click and/or otherwise select a bubble to define an endpoint of an edge. After one endpoint is defined, the user may mouse-drag, mouse-click and/or otherwise select the other endpoint for the edge. In some embodiments, the graphical user interface may include a “snap to bubble” feature to assist the user in defining the second endpoint. In some embodiments, the graphical user interface may not allow the user to define an edge that creates a prohibited type connection. In some embodiments, the interface may allow the user to create such an edge and may inform the user (in some way shape or form) that the connection is prohibited.

FIG. 18B is a dataflow diagram 1810 showing another example of dataflow program semantics that may be used in defining a dataflow network, in accordance with some embodiments. Referring to FIG. 18B, the dataflow diagram 1810 includes nodes A-F. Node B defines an iteration context. Nodes C and D are in the iteration context defined by node B. Node D retracts the iteration context defined by node B. Node E defines an iteration context. Node F is connected to the output of node D and the output of node E. Node D does not produce an iteration context because the iteration context from node B is retracted. Node F is within Node E's iteration context.

Thus, an iteration context that is retracted does not apply to nodes connected after the retraction (e.g., iteration context retracted by node D does not apply to node F).

FIG. 18C is a dataflow diagram 1820 showing an example of dataflow program semantics that may not be permitted in some embodiments. Referring to FIG. 18C, the dataflow diagram 1820 includes nodes A-D. Node B defines an iteration context. Node C also defines an iteration context. An edge 1821 connects an output of node B to a first input of node D. An edge 1822 connects an output of node C to a second input of node D. Thus, node D appears to be in the iteration context defined by node B and in the iteration context defined by node C. In accordance with some embodiments, and as indicated by symbols 1823, 1824, this example may not be permitted because iteration contexts that are not nested may not be joined to the inputs of the same node.

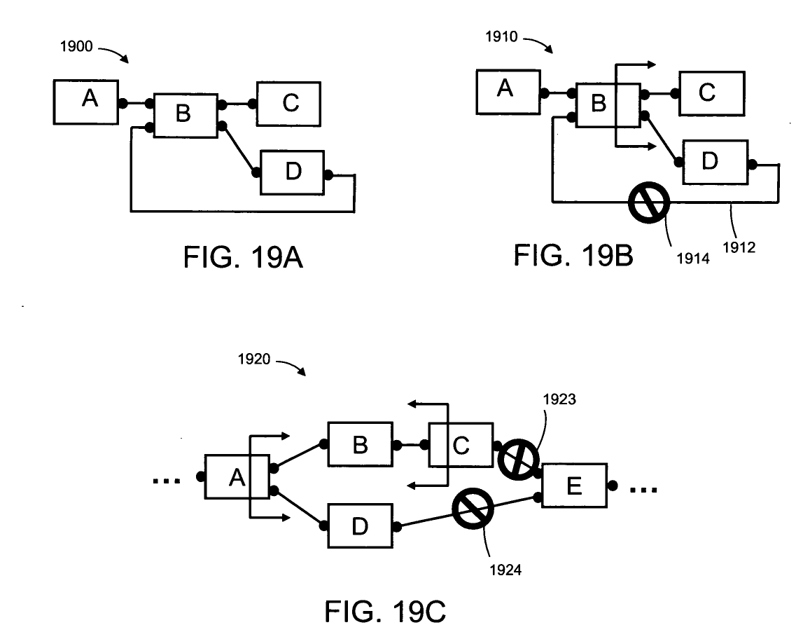

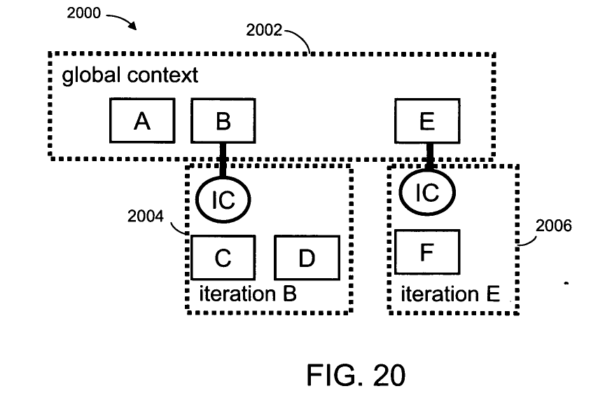

Some embodiments may prevent (or prohibit) iteration contexts from forming loops. A loop is formed if the diagram includes a path from an output of a node to an input of the same node. For example, a loop exists in a situation where starting from a node, a path can be found following a chain of edges from outputs to inputs that leads back to an input of the original node. An example of a loop in a dataflow network 1900 without an iteration context is shown in FIG. 19A. In general, a loop in a dataflow network may have an ambiguous meaning and different systems may apply different semantics to handle the situation. Some embodiments may prevent (or prohibit) loops that cause an iteration context to loop back on itself. FIG. 19B is an example of a dataflow network 1910 with an iteration context that loops back on itself. Specifically, node B defines an iteration context. Nodes C and D are in the iteration context defined by node B. The edge 1912 connects an output of node (i.e., node D) within an iteration context to an input of a node (i.e., node B) that defines such iteration context. As indicated by symbol 1914, some embodiments may not allow loops that cause an iteration context to chain back to its own input or the inputs of an iteration context in which it is nested.

FIG. 19C is a dataflow diagram 1920 showing another example of dataflow program semantics that may not be permitted in some embodiments. Referring to FIG. 19C, the dataflow diagram 1920 includes nodes A-E. Node A defines an iteration context. Nodes B, D and E are in the iteration context defined by node A. Node C retracts the iteration context defined by node A and supplies an output to node E. The node E is in an iteration context defined by node A and uses an output of node C, which retracts the iteration context of node A. Notably, in order to provide a result, node C requires that the iteration context defined by node A be completed. However, in order to complete the iteration context defined by node A, node E requires the result of node C. In accordance with some embodiments, and as indicated by symbols 1923, 1924, this example may not be permitted.

To run a standard dataflow program, the dataflow nodes may first be sorted to determine an order of node invocation. Once the order of node invocation is determined, the function of each node is called in turn. Once every node is called one time, the process starts over from the beginning of the list repeatedly running all the nodes' functions in an endless loop.

In accordance with some embodiments, running a dataflow program using semantics of the present invention may be similar except that allowances are made for the iteration contexts. In some embodiments, after sorting the nodes according to their partial order, nodes are then grouped according to the iteration context in which they are nested (i.e., according to the iteration context that influences it). Every node can be a member of at most one iteration context. As stated above, a node that produces a new iteration context propagates its influence to all successive nodes until either the context is retracted or another iteration context replaces it. Because un-nested iteration contexts are not allowed to be connected to the inputs of the same node, the most deeply nested iteration context that arrives for any node will always be unique. If a node is not influenced by an iteration context, that node is kept in the global context group. In some embodiments, attention is paid to keep the relative order of the nodes in each group the same as it was when they were in the global list. An example showing how nodes in a dataflow diagram may be grouped is described hereinafter with respect to FIG. 20.

In accordance with some embodiments, to execute the nodes, a system calls each node in order. Conventional nodes may compute their values and store results as described in the flowchart 600 (FIG. 6). Nodes with an iteration context may be executed in accordance with the method of the flowchart 700 (FIG. 7). While the iteration context is active, the present invention invokes the nodes stored in the iteration context's group of nodes. Similarly, if one of the nodes within an iteration context's group produces its own iteration context, the new iteration context is invoked recursively until it is complete. Then control returns to the previous iteration context and execution continues.

FIG. 20 is a diagram showing an example of an order and groups for nodes of a dataflow diagram in accordance with some embodiments. More particularly, FIG. 20 is a diagram 2000 showing an example of an order and groups for nodes of the dataflow diagram 1810 (FIG. 18B).

As stated above, the dataflow diagram 1810 (FIG. 18B) includes nodes A-F. Node B defines an iteration context. Nodes C and D are in the iteration context defined by node B. Node D retracts the iteration context defined by node B. Node E defines an iteration context. Node F is connected to the output of node D and the output of node E and is in the iteration context of node E.

Referring to FIG. 20, the diagram 2000 includes a group 2002 for a global context (sometimes referred to hereinafter as a global context group 2002), a group 2004 for the iteration context defined by node B (sometimes referred to hereinafter as iteration B context group 2004) and a group 2006 for the iteration context defined by node E (sometimes referred to hereinafter as iteration E context group 2006). Nodes A, B and E are in the global context group 2002. Nodes C and D are in the iteration B context group 2004. Node F is in the iteration E context group 2006. Within the global context group 2002, node A is before node B, which is before node E. Within the iteration B context group 2004, node C is before node D. Within the iteration E context group 2006, node F is the only node.

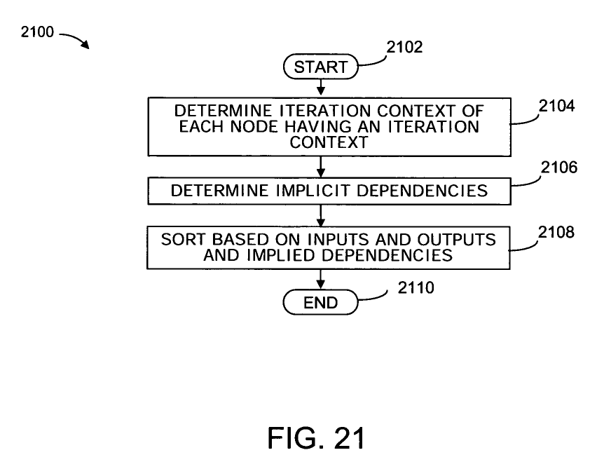

FIG. 21 is a flow chart 2100 of a method that may be used in sorting a dataflow diagram, in accordance with some embodiments. The method may begin at 2102. At 2104, the method may include determining the iteration context of all nodes that have an iteration context. In some embodiments, some nodes may not have an iteration context. At 2106, the method may further include determining any implicit dependencies. At 2108, the method may further include sorting the nodes based at least in part on inputs and outputs and the implied dependencies. The method may end at 2110.

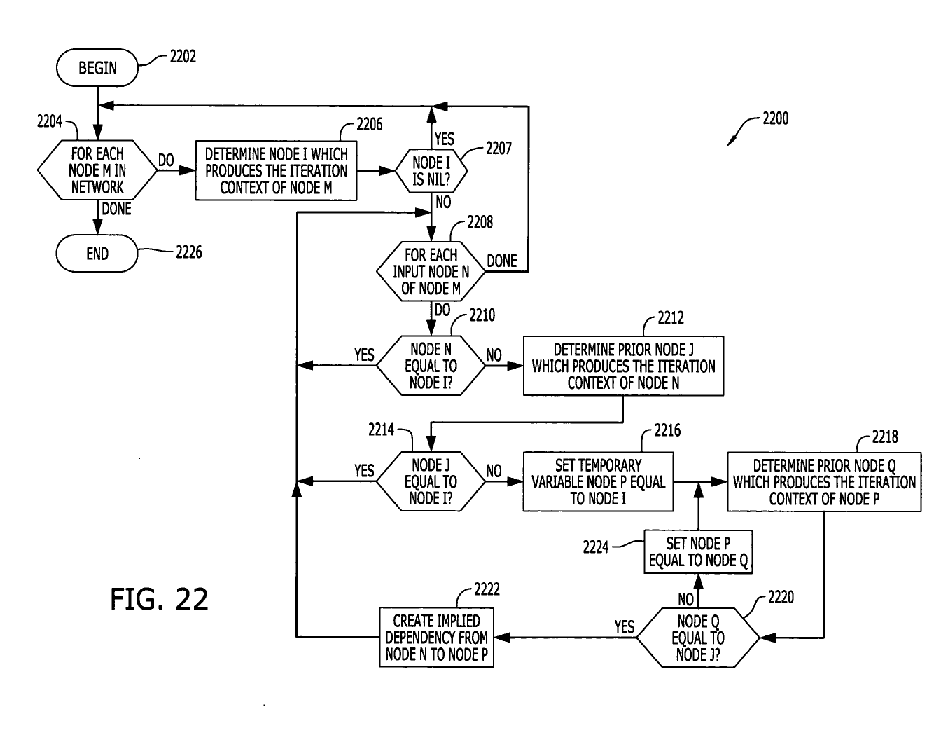

FIG. 22 is a flow chart 2200 of a method that may be used in determining implicit dependencies, in accordance with some embodiments. In accordance with some embodiments, the method may be used in determining implicit dependencies at 2106 (FIG. 21) in the method of FIG. 21. Referring to FIG. 22, the method may begin at 2202. At 2204, the method may include selecting a node in the network, such node being referred to hereinafter as node M. For each node M in the network, the method determines at 2206 the node I which produces the iteration context of the node M (i.e., whether node M has an iteration context defined by a node I). That is, it is determined whether node M is within the iteration context defined by another preceding node I.

If node M does not have an iteration context (i.e., node I is nil) at 2207, then the method returns to 2204 to determine whether any nodes in the network have not yet been selected, and if so, then execution may return to 2206 for the next selected node M. If node M has an iteration context (i.e., node I is not nil) at 2207, then the method at 2208 selects and evaluates a node N that is an input node of node M.

For the selected input node N, at 2210, the method determines if input node N is equal to node I. If so, then input node N is the node that produces the iteration context of node M, and the method returns to 2208 to determine whether any input nodes of node M have not yet been selected and evaluated.

If determined at 2210 that input node N is not equal to node I, then input node N is not the node that produced the iteration context of node M, and at 2212, the method may include determining a prior node J that produces or defines an iteration context of input node N. As discussed above, in accordance with some embodiments, if a node retracts an iteration context, the iteration context for successive (or following) nodes reverts to the prior iteration context, i.e., the iteration context defined previous to the iteration context of the node that defined the retracted iteration context. If there was no prior iteration context, then the successive nodes act as nodes having no iteration context. A new iteration context defined by a node replaces the current iteration context for following nodes. Thus, a given node has only one iteration context. When an iteration context is replaced by a new iteration context, the new iteration context is considered to be “nested” within the previous iteration context.

At 2214, the method may further include determining whether node J is equal to node I. If node J is equal to node I, then the node that produces the iteration context of the input node N is the same as the node that produces the iteration context of node M, and the method may continue at 2208 to determine whether any input nodes of node M have not yet been selected.

If determined at 2214 that node J is not equal to node I, then node M has a different iteration context than input node N, and at 2216, a temp node P is set equal to node I (i.e., the node that produces the iteration context for node M). At 2218, the method may include determining a prior node Q that produces an iteration context of temp node P. At 2220, the method may further include determining whether node Q is equal to node J. If node Q is equal to node J, then the prior node that produces the iteration context of temp node P is the same as the prior node that produces the iteration context of input node N, and the method may include creating at 2222 an implied dependency from input node N to temp node P. Then the method continues at 2208 for the next selected input node N.

If determined at 2220 that node Q is not equal to node J, then the node that produces the iteration context of temp node P is not the same as the node that produces the iteration context of input node N. Then, at 2224, temp node P is set equal to node Q (i.e., the node that produces the iteration context for temp node P) and execution continues at 2218.

If all of the input nodes N of node M have been evaluated and each node M of the network has been evaluated, then the method at 2204 is done and the method ends at 2226.

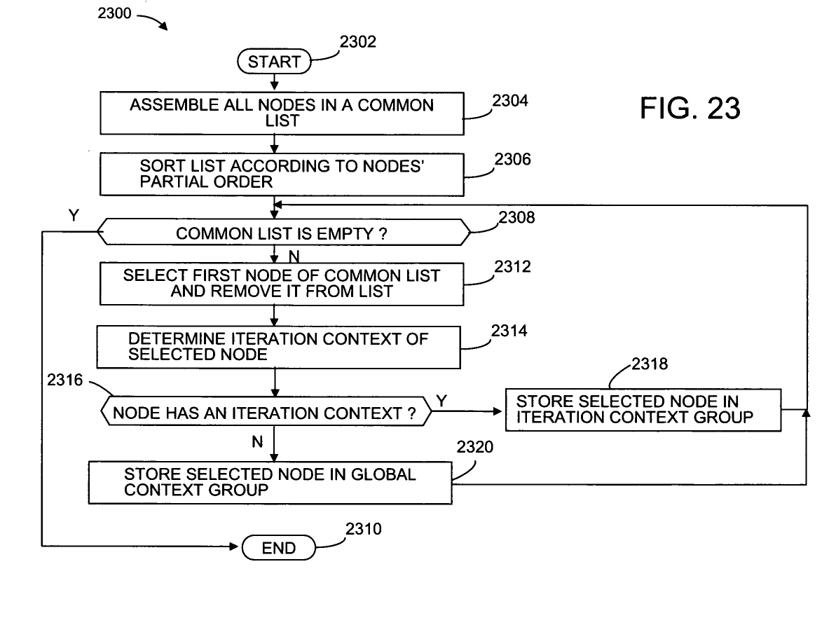

FIG. 23 is a flow chart 2300 of a method that may be used in sorting the nodes based at least in part on inputs and outputs and implied dependencies, in accordance with some embodiments. In accordance with some embodiments, the method may be used at 2108 (FIG. 21) in sorting based at least in part on inputs and outputs and implied dependencies in the method of FIG. 21.

Referring to FIG. 23, the method may begin at 2302. At 2304, the method may include assembling all nodes in a common list. At 2306, the method may further include sorting the list according to the nodes' partial order. At 2308, the method may further include determining whether the common list is empty. If the common list is empty, the method may end at 2310. If the common list is not empty, the method may include selecting at 2312 a first node of the common list and removing it from the common list. At 2314, the method may further include determining an iteration context of the selected node. At 2316, the method may further include determining whether the node has an iteration context. If the node has an iteration context, then at 2318, the method may further include storing the selected node in an iteration context group associated with the iteration context of the selected node, and execution may return to 2308. If determined at 2316 that the node does not have an iteration context, then at 2320, the method may further include storing the selected node in a global context group, and execution may return to 2308. Thereafter, 2308-2320 may be repeated until, at 2308, it is determined that the common list is empty.

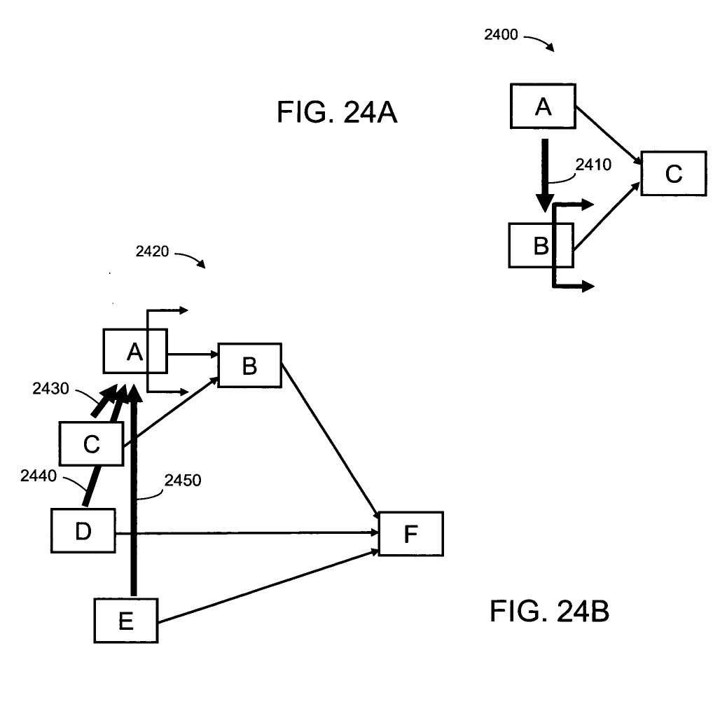

FIG. 24A is a dataflow diagram 2400 showing an example of a dataflow network and an implied dependency that may be determined for the dataflow network, in accordance with some embodiments. In some embodiments, the implied dependency may be determined using one or more portions of the method set forth in FIG. 22.

Referring to FIG. 24A, the dataflow diagram 2400 includes nodes A-C. Node B defines an iteration context. Node C is in the iteration context defined by node B. Node A and node B are the input nodes for node C. Since node C requires node A's output value, node B's iteration can only start once node A's value is computed. Thus, an implied dependency 2410 is created between node A and node B so that when the nodes are sorted, node B must come after node A.

FIG. 24B is a dataflow diagram 2420 showing an example of a dataflow network and implied dependencies that may be determined for the dataflow network, in accordance with some embodiments. In some embodiments, the implied dependency may be determined using one or more portions of the method set forth in FIG. 22.

Referring to FIG. 24B, the dataflow diagram 2420 includes nodes A-F. Node A defines an iteration context. Nodes B and F are in the iteration context defined by node A. Node A and node C are the input nodes for node B. However, node C is not in the iteration context defined by node A. An implied dependency is created for each input node that is not in the iteration context defined by node A. Thus, an implied dependency 2430 is created between node C and node A so that when the nodes are sorted, node A must come after node C.

Node B, node D and node F are the input nodes for node F. However, nodes D and E are not in the iteration context defined by node A. As discussed above, an implied dependency is created for each input node that is not in the iteration context defined by node A. Thus, an implied dependency 2440 is created between node D and node A so that when the nodes are sorted, node A must come after node D. In addition, an implied dependency 2450 is created between node E and node A so that when the nodes are sorted, node A must come after node E.

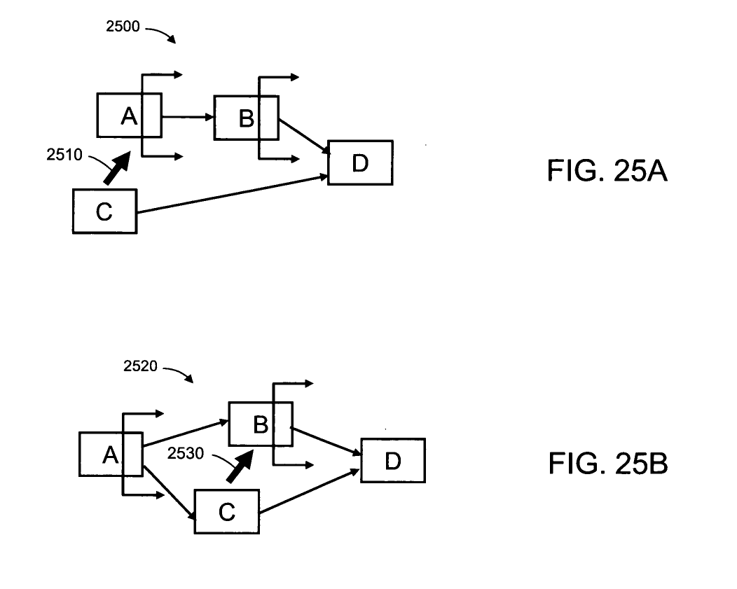

FIG. 25A is a dataflow diagram 2500 showing an example of a dataflow network and an implied dependency that may be determined for the dataflow network, in accordance with some embodiments. In some embodiments, the implied dependency may be determined using one or more portions of the method set forth in FIG. 22.

Referring to FIG. 25A, the dataflow diagram 2500 includes nodes A-D. Node A defines an iteration context. Node B also defines an iteration context. Node B is in the iteration context defined by node A. Node D is in the iteration context defined by node B. Node B and node C are input nodes for node D. However, node C is not in the iteration context defined by node B. An implied dependency is created for each input node that is not in the iteration context defined by node B. Thus an implied dependency is created from input node C to a foremost node that produces an iteration context that is active on node D. The iteration context defined by node A and the iteration context defined by node B are active on node D. Node A precedes node B. Thus, an implied dependency 2510 is created between node C and node A so that when the nodes are sorted, node A must come after node C.

FIG. 25B is a dataflow diagram 2520 showing an example of a dataflow network and an implied dependency that may be determined for the dataflow network, in accordance with some embodiments. In some embodiments, the implied dependency may be determined using one or more portions of the method set forth in FIG. 22.

Referring to FIG. 25B, the dataflow diagram 2520 includes nodes A-D. Node A defines an iteration context. Node B also defines an iteration context. Node B and node C are in the iteration context defined by node A. Node D is in the iteration context defined by node B. Node B and node C are input nodes for node D. However, node C is not in the iteration context defined by node B. An implied dependency is created for each input node that is not in the iteration context defined by node B. Thus, an implied dependency 2530 is created between node C and node B so that when the nodes are sorted, node B must come after node C.

This example of FIG. 25B is similar to the last example of FIG. 25A except that in the example of FIG. 25B node C follows node A's iteration context. Now, the foremost iteration context is produced by node B because node A's context is shared. An implied dependency is created from node C to node B.

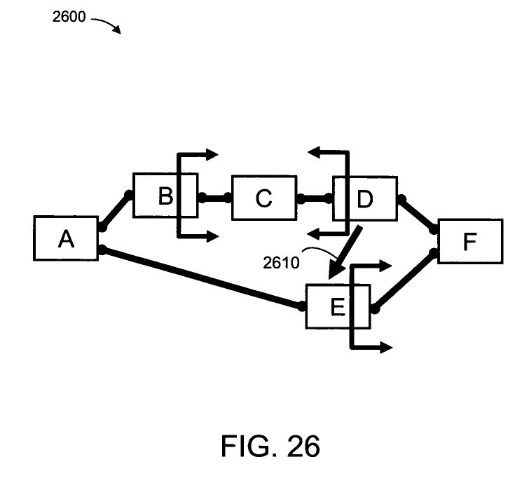

FIG. 26 is a dataflow diagram 2600 showing an example of a dataflow network and an implied dependency that may be determined for the dataflow network, in accordance with some embodiments. In some embodiments, the implied dependency may be determined using one or more portions of the method set forth in FIG. 22.

Referring to FIG. 26, the dataflow diagram 2600 includes nodes A-F. Node B defines an iteration context. Node D retracts the iteration context defined by node B. Node E also defines an iteration context. Node D and node E are input nodes for node F. Node D is not in the iteration context defined by node E. An implied dependency is created for each input node that is not in the iteration context defined by node E. An implied dependency 2610 is created between node D and node E so that when the nodes are sorted, node E must come after node D.

In accordance with some embodiments, the system may determine using the method of FIG. 22 where “implicit dependencies” exist as follows for the example of FIG. 26:

For node M=node A: node M does not follow an iteration context (i.e., node A is not within the iteration context defined by another node and node I is nil) so the method executes up to 2207 then returns to 2204.

For node M=node B: node B does not follow an iteration context (i.e., node I is nil) so the method executes up to 2207 then returns to 2204.

For node M=node C: node C follows the iteration context defined by input N=node B (i.e., node C is within the iteration context defined by node B, so node I=node B=node N) but has no other inputs. Accordingly, the method executes up to 2210 and returns to 2208 and then to 2204.

For node M=node D: node D follows the iteration context defined by input node N=node B (i.e., node D is within the iteration context defined by node B, so node I=node B=node N) but has no other inputs. Accordingly, the method executes up to 2210 and returns to 2208 and then to 2204.

For node M=node E: node E does not follow an iteration context (i.e., node E is not within the iteration context defined by another node and node I is nil) so the method executes up to 2207 and then returns to 2204.

For node M=Node F: node F follows the iteration context defined by node E (i.e., node I=node E). For input node N=node E, node N=node I, so the method executes up to 2210 and returns to 2208. Node F has one other input from node D. For input node N=node D, node N does not equal node I, so the method proceeds to 2212. As discussed in connection with FIG. 22, a node retracting an iteration context (in this example, node D) reverts to the prior iteration context (i.e., the iteration context defined previous to the iteration context of the node that defined the retracted iteration context (in this example, node B defined the iteration context that was retracted by node D). Since node B follows no iteration context, the node J is determined in 2212 to be nil. At 2214 it is determined that node J=nil is not equal to node I=node E, so the method proceeds to 2216. Temp node P=node I=node E, and at 2218, node Q is determined to be nil (since node P=node E does not follow an iteration context defined by a prior node). Since node Q=nil and equals node J=nil, the method at 2222 creates an implied dependency from node N=node D to temp node P=node E. Since an iteration context does not follow from node F's input node D, and an iteration context does follow from node F's other input node E, node F requires node D's output value before node E's iteration can start. Thus, an implied dependency 2610 is created between node D and node E so that when the nodes are sorted, node E must come after node D.

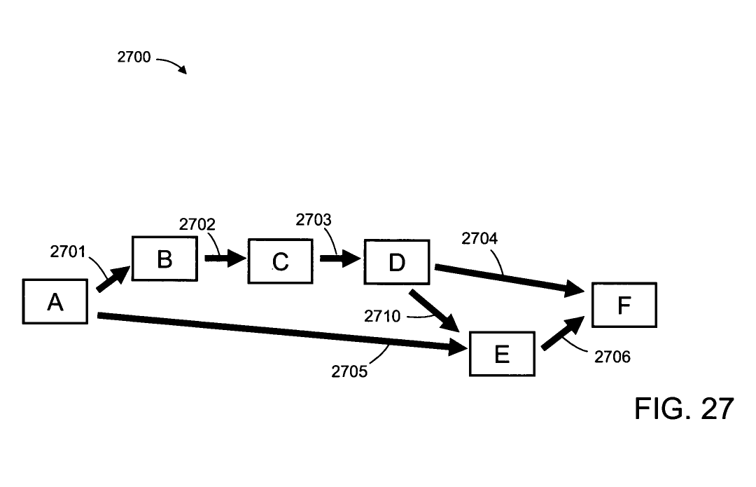

FIG. 27 is a diagram 2700 showing an example of all the dependencies for the dataflow network 2600 (FIG. 26), in accordance with some embodiments. Referring to FIG. 27, in accordance with some embodiments, the dependencies include dependencies 2701-2706 associated with dataflow links and/or edges and an implied dependency 2710.

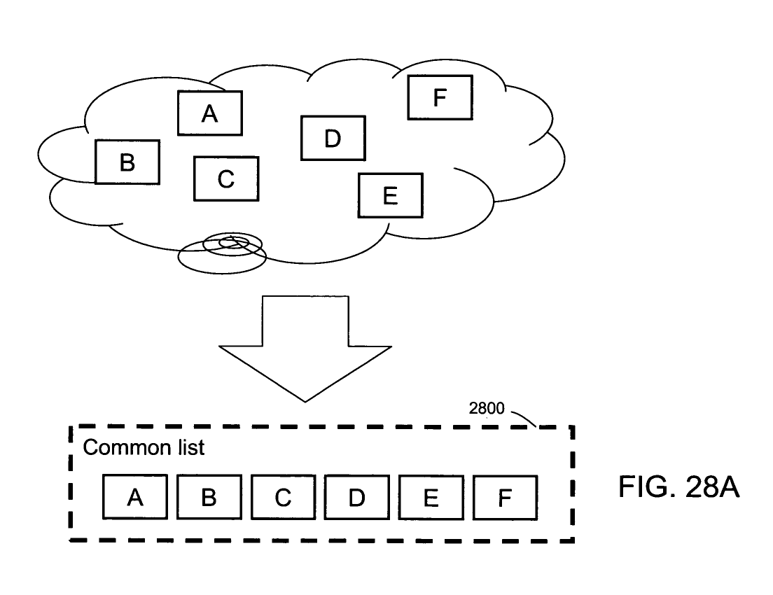

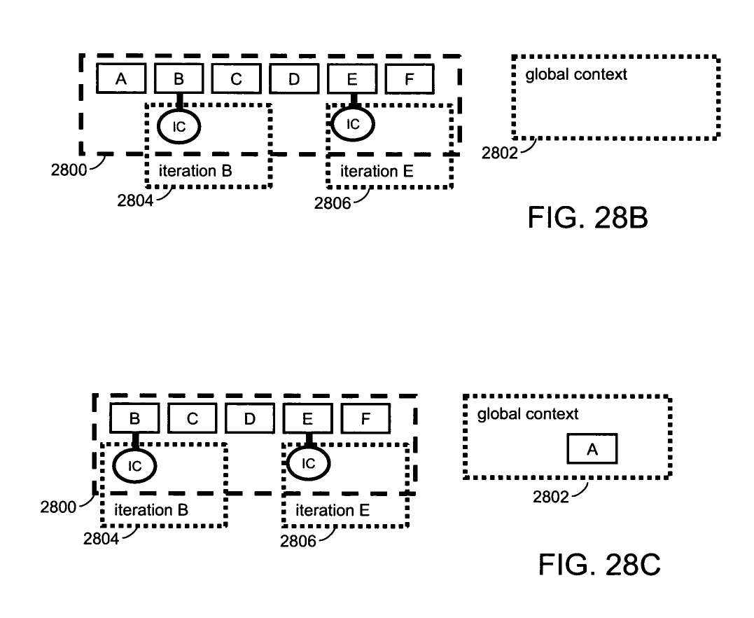

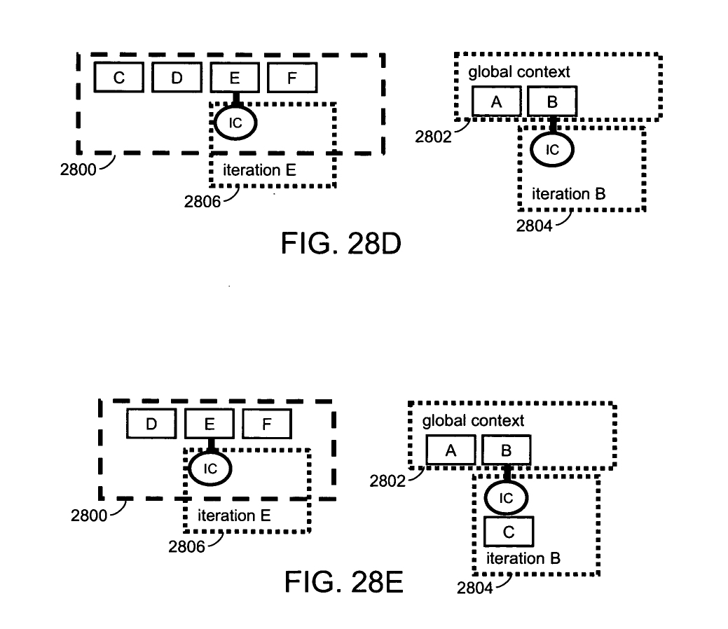

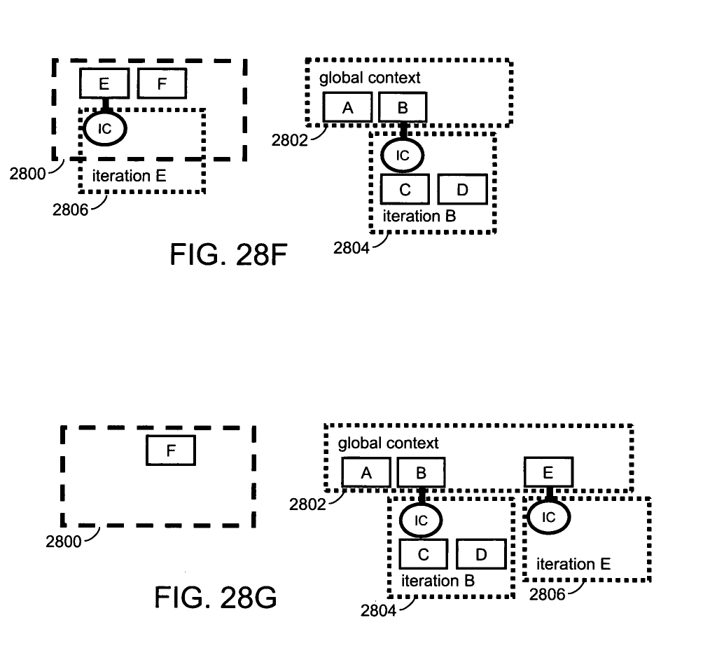

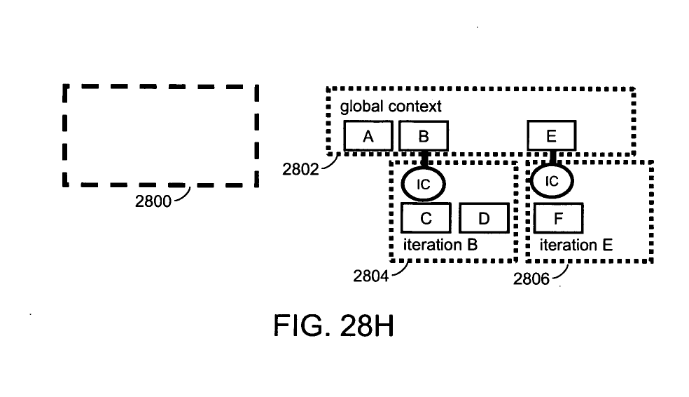

FIGS. 28A-28H show an example of how nodes of a dataflow diagram may be sorted and grouped using the method set forth in FIG. 23. More particularly, FIGS. 28A-28H show an example of how nodes of the dataflow diagram 2600 (FIG. 26) may be sorted and grouped using the method set forth in FIG. 23 to obtain the order and groups shown in FIG. 20, in accordance with some embodiments.

As stated above, the dataflow diagram 2600 (FIG. 26) includes nodes A-F. Node B defines an iteration context. Nodes C and D are in the iteration context defined by node B. Node D retracts the iteration context defined by node B. Node E defines an iteration context. Node F is connected to the output of node D and the output of node E.

Referring to FIG. 28A, after implied dependencies have been added, the nodes of the dataflow diagram may be assembled (or inserted) into a common list 2800 and sorted according to the partial order of such nodes. In accordance with some embodiments, the sorted nodes may have the following order: node A, node B, node C, node D, node E and node F.

Referring to FIG. 28B, each node may ultimately be removed from the common list 2800 and inserted into one of three groups: a group 2802 for a global context (sometimes referred to hereinafter as a global context group 2802), a group 2804 for the iteration context defined by node B (sometimes referred to hereinafter as iteration B context group 2804) and a group 2806 for the iteration context defined by node E (sometimes referred to hereinafter as iteration E context group 2806).

Referring to FIG. 28C, node A may be removed from the common list 2800. Because node A does not follow an iteration context, node A may be added to the global context group 2802.

Referring to FIG. 28D, node B may be removed from the common list 2800. Because node B does not follow an iteration context, node B may be added to the global context group 2802.

Referring to FIG. 28E, node C may be removed from the common list 2800. Because node C follows iteration context B, node C may be added to the iteration B context group 2804.

Referring to FIG. 28F, node D may be removed from the common list 2800. Because node D follows iteration context B, node D may be added to the iteration B context group 2804.

Referring to FIG. 28G, node E may be removed from the common list 2800. Because node E does not follow an iteration context, node E may be added to the global context group 2802.

Referring to FIG. 28H, node F may be removed from the common list 2800. Because node F follows iteration context E, node F may be added to the iteration E context group 2806.

FIG. 28H shows the nodes sorted and grouped. Nodes A, B and E are in the global context group 2802. Nodes C and D are in the iteration B context group 2804. Node F is in the iteration E context group 2806. Within the global context group 2802, node A is before node B, which is before node E. Within the iteration B context group 2804, node C is before node D. Within the iteration E context group 2806, node F is the only node.

FIG. 29 is a block diagram of a processing system 2900, in accordance with some embodiments. In some embodiments, the processing system 2900 may be used to carry out one or more portions of one or more embodiments disclosed herein. In accordance with some embodiments, the processing system 2900 may comprise a dataflow processing system to carry out one or more portions of one or more embodiments disclosed herein and/or a simulation processing system to carry out one or more portions of one or more embodiments disclosed herein.

Referring to FIG. 29, in some embodiments, the processing system 202 includes a processor 2901 operatively connected to a communication device 2902, an input device 2906, an output device 2907 and a storage device 2908. The communication device 2902 may be used to facilitate communication with, for example, other devices. The input device 2906 may comprise, for example, one or more devices used to input data and information, such as, for example: a keyboard, a keypad, a mouse or other pointing device, a microphone, knob or a switch, an infra-red (IR) port, etc.

The output device 2907 may comprise, for example, one or more devices used to output data and information, such as, for example: an IR port, a docking station, a display, a speaker, and/or a printer, etc. The storage device 2908 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 2908 may store one or more programs 2910, which may include one or more instructions to be executed by the processor 2901 to perform one or more portions of one or more embodiments disclosed herein.

In some embodiments, one or more of the programs 2910 may include one or more programs for processing one or more portions of one or more dataflow diagrams that include one or more portions of one or more embodiments disclosed herein.

As stated above, in accordance with some embodiments, to run a standard dataflow program, the dataflow nodes may first be sorted to determine an order of node invocation. Once the order of node invocation is determined, the function of each node is called in turn. Once every node is called one time, the process starts over from the beginning of the list repeatedly running all the nodes' functions in an endless loop. In accordance with some embodiments, running a dataflow program using semantics of the present invention may be similar except that allowances are made for the iteration contexts.

In some embodiments, one or more of the programs 2910 may include one or more programs for processing one or more portions of one or more simulations that include one or more portions of one or more embodiments disclosed herein.

Data representing a dataflow network may be supplied by and/or received from any source(s). Notably, in some embodiments, the data may be received from one or more sources within the processing system 2900. In some embodiments, the data may be received from one or more sources outside the processing system 2900. In some embodiments, the data may be receive from one or more sources within the processing system and one or more outside the processing system 2900. As stated above, in some embodiments, the processing system 2900 comprises a dataflow processing system.

In some embodiments, data representing a dataflow network may be supplied by a user via a user interface. In some embodiments, nodes and/or edges may be rendered using typical computer graphical user interface displays. In some embodiments, node may be shown as a box or icon of some sort. The shape and/or size of different types of nodes can vary widely. That is, in some embodiments, nodes may not be depicted as rectangular.

In some embodiments, data representing a dataflow network may be received via the communication device 2902. In some embodiments, data representing a dataflow network may be stored on and/or received from the storage device 2908. In some embodiments, data representing a dataflow network may be received from a combination of the above. In some embodiments, data representing a dataflow network may be received from one or more sources in lieu of and/or in addition to one or more of the sources described herein.

In some embodiments, storage device 2908 may store one or more databases, including, for example, a dataflow diagram database 2912 (which may include, for example, one or more portions of one or more dataflow diagrams that include one or more portions of one or more embodiments disclosed herein), a simulation database 2914 (which may include, for example, one or more portions of one or more simulations that include one or more portions of one or more embodiments disclosed herein) and/or one or more other databases 2916.

Other programs and/or databases may also be employed.

As used herein, a processing system may be any type of processing system and a processor may be any type of processor. For example, a processing system may be programmable or non programmable, digital or analog, general purpose or special purpose, dedicated or non dedicated, distributed or non distributed, shared or not shared, and/or any combination thereof. A processing system may employ continuous signals, periodically sampled signals, and/or any combination thereof. If the processing system has two or more distributed portions, the two or more portions may communicate with one another through a communication link. A processor system may include, for example, but is not limited to, hardware, software, firmware, hardwired circuits and/or any combination thereof.

Thus, in some embodiments, a processing system may include any sort or implementation of software, program, sets of instructions, code, ASIC, or specially designed chips, logic gates, or other hardware structured to directly effect or implement such software, programs, sets of instructions or code. The software, program, sets of instructions or code can be storable, writeable, or savable on any computer usable or readable media or other program storage device or media such as, for example, floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

As used herein, a communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

In accordance with some embodiments, the present invention defines semantics for a dataflow diagram language so that it is better able to handle data stored as list-like collections of arbitrary types. First, the dataflow network permits the use of dynamically sized lists for any data edge connection. Second, it allows nodes to be defined that have an “iteration context.” A node with an iteration context controls the number of times that nodes connected its outputs are invoked. Third, a node can be defined to eliminate a level of iteration context so that nodes connected to its output are not controlled by the node that originated an iteration context.

In accordance with some embodiments, the present invention allows data from both input and output connections of nodes to form ordered lists of arbitrary length. There are many kinds of data types that resemble lists and are treated by the present invention in the same manner. For example, a vector or array is a list with fixed size whose values can be accessed by an integer index. A set is an unordered list of a fixed set of values. The programmer implements these types using the generic list type.

In accordance with some embodiments, the present invention provides new semantics for dataflow programming that permit simpler handling of arbitrarily-sized list data. Unlike standard dataflow programming languages that require the programmer to create a second diagram embedded within a node of the main diagram, the present invention allows the programmer to handle lists within a single diagram.

In accordance with some embodiments, the present invention defines an iteration context that a dataflow node can use to influence the behavior of successive nodes connected to its output. The iteration context is used to invoke nodes as many times as is needed to support the computation. This is important because an arbitrary list can have any number of elements (including possibly being empty).

In accordance with some embodiments, nodes can both produce and retract an iteration context. Each context forms an implicit nesting where the nested dataflow nodes are invoked a number of times controlled by the node that produced the iteration context. This feature is primarily used for array manipulation, as performed by the fan-in and fan-out nodes, but can also be used for other purposes such as the guard node.

In accordance with some embodiments, by implementing iteration directly in a single diagram, the programmer has to manage fewer programming conventions. Connecting nodes that produce iteration contexts in a diagram is identical to connecting all other nodes. There is also no need to create multiple diagrams for list processing tasks. Keeping the dataflow program together in a single diagram reduces the risk of not seeing code because the embedded part of the diagram is not on screen.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Although various features, attributes and/or advantages may be described herein and/or may be apparent in light of the description herein, it should be understood that unless stated otherwise, such features, attributes and/or advantages are not required and need not be present in all aspects and/or embodiments.

While various embodiments have been described, such description should not be interpreted in a limiting sense. It is to be understood that modifications of such embodiments, as well as additional embodiments, may be utilized without departing from the spirit and scope of the invention, as recited in the claims appended hereto. It is therefore contemplated that the appended claims will cover any such modifications or embodiments as fall within the true scope of the invention.

What is claimed is:

1. A method comprising:
receiving, in a processing system, data representing a dataflow network, the dataflow network including a first node and a second node, the first node having an output, the second node having an input connected to the output of the first node; and
determining, in the processing system, whether to execute the second node based at least in part on whether the first node has data to present.

2. The method of claim 1 wherein determining whether to execute the second node based at least in part on whether the first node has data to present comprises:
determining whether to execute the second node based at least in part on whether the first node has a result to present.

3. The method of claim 1 wherein determining whether to execute the second node based at least in part on whether the first node has data to present comprises:
executing the first node to determine whether the first node has a result to present.

4. The method of claim 1 wherein determining whether to execute the second node based at least in part on whether the first node has data to present comprises:
determining to execute the second node if the first node has data to present.

5. The method of claim 1 further comprising:
executing the second node if the first node has data to present.

6. The method of claim 1 further comprising:
not executing the second node if the first node does not have data to present.

7. A storage medium having stored thereon instructions that if executed by a machine, result in the following:
receiving, in a processing system, data representing a dataflow network, the dataflow network including a first node and a second node, the first node having an output, the second node having an input connected to the output of the first node; and
determining, in the processing system, whether to execute the second node based at least in part on whether the first node has data to present.

8. The storage medium of claim 7 wherein determining whether to execute the second node based at least in part on whether the first node has data to present comprises:
determining whether to execute the second node based at least in part on whether the first node has a result to present.

9. The storage medium of claim 7 wherein determining whether to execute the second node based at least in part on whether the first node has data to present comprises:
executing the first node to determine whether the first node has a result to present.

10. The storage medium of claim 7 wherein determining whether to execute the second node based at least in part on whether the first node has data to present comprises:
determining to execute the second node if the first node has data to present.

11. The storage medium of claim 7 further comprising:
executing the second node if the first node has data to present.

12. The storage medium of claim 7 further comprising:
not executing the second node if the first node does not have data to present.

13. Apparatus comprising:
means for receiving data representing a dataflow network, the dataflow network including a first node and a second node, the first node having an output, the second node having an input connected to the output of the first node; and
means whether to execute the second node based at least in part on whether the first node has data to present.

14. The apparatus of claim 13 wherein the means for determining whether to execute the second node based at least in part on whether the first node has data to present comprises:
means for determining whether to execute the second node based at least in part on whether the first node has a result to present.

15. The apparatus of claim 13 wherein the means for determining whether to execute the second node based at least in part on whether the first node has data to present comprises:
means for executing the first node to determine whether the first node has a result to present.

16. The apparatus of claim 13 wherein the means for determining whether to execute the second node based at least in part on whether the first node has data to present comprises:
means for determining to execute the second node if the first node has data to present.

17. The apparatus of claim 13 further comprising:
means for executing the second node if the first node has data to present.

18. The apparatus of claim 13 further comprising:
means for not executing the second node if the first node does not have data to present.

19. Apparatus comprising:
a processing system to (1) receive data representing a dataflow network, the dataflow network including a first node and a second node, the first node having an output, the second node having an input connected to the output of the first node; and (2) determine whether to execute the second node based at least in part on whether the first node has data to present.

20. The apparatus of claim 19 wherein the processing system comprises a processing system to determine whether to execute the second node based at least in part on whether the first node has a result to present.

21. The apparatus of claim 19 wherein the processing system comprises a processing system to execute the first node to determine whether the first node has a result to present.

22. The apparatus of claim 19 wherein the processing system comprises a processing system to execute the second node if the first node has data to present.

23. The apparatus of claim 19 wherein the processing system does not execute the second node if the first node does not have data to present.

24. A method comprising:
receiving, in a processing system, data representing a dataflow network, the dataflow network including a first node and a second node, the first node having an output, the second node having an input connected to the output of the first node; and
executing the first node to determine whether to execute the second node.

25. The method of claim 24 further comprising:
executing the second node first node if the determination is to execute the second node.

26. An apparatus comprising:
a processing system to (1) receive data representing a dataflow network, the dataflow network including a first node and a second node, the first node having an output, the second node having an input connected to the output of the first node and (2) execute the first node to determine whether to execute the second node.

27. The apparatus of claim 26 wherein the processing system comprises a processing system to execute the second node first node if the determination is to execute the second node.
